(19) United States
(12) Patent Application Publication
(10) Pub. No.: US 2024/0106185 A1
(43) Pub. Date: Mar. 28, 2024

(54) OPTICAL PULSE GENERATION DEVICE AND OPTICAL PULSE GENERATION METHOD

(71) Applicant: HAMAMATSU PHOTONICS K.K., Hamamatsu-shi, Shizuoka (JP)

(72) Inventor: Koji TAKAHASHI, Hamamatsu-shi, Shizuoka (JP)

(73) Assignee: HAMAMATSU PHOTONICS K.K., Hamamatsu-shi, Shizuoka (JP)

(21) Appl. No.: 18/266,026

(22) PCT Filed: Oct. 5, 2021
(86) PCT No.: PCT/JP2021/036806

§ 371 Date: Jun. 8, 2023

(30) Foreign Application Priority Data
Dec. 21, 2020 (JP) 2020-211591

(51) Int. Cl. H01S 3/1118; H01S 3/102

(52) U.S. Cl. CPC H01S 3/1118; H01S 3/1024

(57) ABSTRACT

An optical pulse generation device includes an optical resonator of mode-locked type, a light source, and a waveform controller. The optical resonator includes an optical amplification medium and generates, amplifies, and outputs laser light. The light source is optically coupled to the optical resonator and supplies excitation light to the optical amplification medium. The waveform controller is arranged in the optical resonator, and controls a time waveform of the laser light within a predetermined period to convert the laser light into an optical pulse train including two or more optical pulses within a period of the optical resonator. The optical resonator amplifies the optical pulse train after the predetermined period and outputs the optical pulse train having amplified as the laser light.

### TECHNICAL FIELD

The present disclosure relates to an optical pulse generation device and an optical pulse generation method.

### BACKGROUND ART

Non-Patent Literature 1 discloses a technique for controlling the time interval between optical pulses by laser-oscillating a plurality of optical pulses in a mode-locked optical fiber laser and adjusting the pump light intensity. Non-Patent Literature 2 discloses a technique for discretely changing the time interval between two temporally close optical pulses by adjusting the pump light intensity. Non-Patent Literature 3 discloses a technique for controlling the number of optical pulses by arranging a variable band filter in an optical resonator in a mode-locked optical fiber laser and adjusting the pump light intensity and the filter width of the variable band filter.

### CITATION LIST

### Non Patent Literature

Non-Patent Literature 1: Ying Yu et al., “Pulse-spacing manipulation in a passively mode-locked multipulse fiber laser”, Optics Express, Vol. 25, Issue 12, pp. 13215-13221, 2017 Non-Patent Literature 2: F. Kurtz et al., “Resonant excitation and all-optical switching of femtosecond soliton molecules”, Nature Photonics, Vol. 14, pp. 9-13, 2020
Non-Patent Literature 3: Zengrun Wen et al., “Effects of spectral filtering on pulse dynamics in a mode-locked fiber laser with a bandwidth tunable filter”, Journal of the Optical Society of America B, Vol. 36, Issue 4, pp. 952-958, 2019

### SUMMARY OF INVENTION

### Technical Problem

In recent years, applications of an optical pulse train including two or more temporally close ultrashort optical pulses have been studied. The ultrashort optical pulse is an optical pulse having a duration of, for example, less than 1 nanosecond. The time interval between optical pulses in the optical pulse train is, for example, less than 10 nanoseconds. As an example, this optical pulse train is applied to the field of laser processing in which laser light is used to process the shape of an object. In the field of laser processing, it is possible to realize high-precision processing regardless of materials by non-thermal processing using ultrashort optical pulses. In addition, as compared with a case of repeatedly emitting a single optical pulse to an object, it is possible to increase the throughput by burst laser processing in which an optical pulse train including two or more consecutive optical pulses is repeatedly emitted to the object. Important parameters in burst laser processing and the like are the number of pulses in a pulse train and the time interval between pulses. Therefore, it is desired that an optical pulse train having a predetermined number of pulses and a predetermined time interval can be stably output with good reproducibility.

It is an object of the present disclosure to provide an optical pulse generation device and an optical pulse generation method capable of stably outputting laser light, which is an optical pulse train including two or more temporally close ultrashort optical pulses, with a predetermined number of pulses and a predetermined time interval with good reproducibility.

### Solution to Problem

An optical pulse generation device according to one aspect of the present disclosure includes an optical resonator of mode-locked type, a light source, and a waveform controller. The optical resonator includes an optical amplification medium and generates, amplifies, and outputs laser light. The light source is optically coupled to the optical resonator and supplies excitation light to the optical amplification medium. The waveform controller is arranged in the optical resonator, and controls a time waveform of the laser light within a predetermined period to convert the laser light into an optical pulse train including two or more optical pulses within a period of the optical resonator. The optical resonator amplifies the optical pulse train after the predetermined period and outputs the optical pulse train having amplified as the laser light.

An optical pulse generation method according to one aspect of the present disclosure includes a laser light generation, a waveform control, and an output. In the laser light generation, laser light is generated and amplified in an optical resonator of mode-locked type by applying excitation light to an optical amplification medium in the optical resonator. In the waveform control, a time waveform of the laser light in the optical resonator is controlled within a predetermined period to convert the laser light into an optical pulse train including two or more optical pulses within a period of the optical resonator. In the output, the optical pulse train is amplified in the optical resonator after the predetermined period and output to an outside of the optical resonator as the laser light.

### Advantageous Effects of Invention

According to the optical pulse generation device and the optical pulse generation method according to one aspect of the present disclosure, it is possible to stably output laser light, which is an optical pulse train including two or more temporally close ultrashort optical pulses, with a predetermined number of pulses and a predetermined time interval with good reproducibility.

### BRIEF DESCRIPTION OF DRAWINGS

FIG. 1 is a block diagram showing the configuration of an optical pulse generation device according to an embodiment.

FIG. 2 is a schematic diagram of an optical resonator.

FIG. 3 is a diagram showing a configuration example of a pulse shaper as an example of a waveform control device.

FIG. 4 is a diagram showing a modulation surface of a spatial light modulator (SLM).

FIG. 5 is a flowchart showing an optical pulse generation method.
(a) and (b) in FIG. 6 are diagrams showing each stage in the operation of the optical pulse generation device.
(a) and (b) in FIG. 7 are diagrams showing each stage in the operation of the optical pulse generation device.
(a) and (b) in FIG. 8 are diagrams showing each stage in the operation of the optical pulse generation device.

FIG. 9 is a diagram showing each stage in the operation of the optical pulse generation device.
(a) in FIG. 10 shows a spectral waveform of single-pulse ultrashort pulsed laser light, and (b) in FIG. 10 shows a time intensity waveform of the ultrashort pulsed laser light.
(a) in FIG. 11 shows a spectral waveform of output light from a pulse shaper when the SLM performs rectangular-wave phase spectrum modulation, and (b) in FIG. 11 shows a time intensity waveform of the output light.

FIG. 12 is a diagram showing a procedure for calculating the phase spectrum by an iterative Fourier transform method.

FIG. 13 is a diagram showing a procedure for calculating a phase spectrum function.

FIG. 14 is a diagram showing a procedure for calculating the spectral intensity.

FIG. 15 is a diagram showing an example of a procedure for generating a target spectrogram.

FIG. 16 is a diagram showing an example of a procedure for calculating an intensity spectrum function.
(a) in FIG. 17 is a diagram showing a spectrogram SG_{IFTA}(ω, t), and (b) in FIG. 17 is a diagram showing a target spectrogram TargetSG₀(ω, t) to which the spectrogram SG_{IFTA}(ω, t) is changed.

FIG. 18 is a flowchart showing the operation of an optical pulse generation device and an optical pulse generation method according to a first modification example.

FIG. 19 is a block diagram showing the configuration of an optical pulse generation device according to a second modification example.

FIG. 20 is a flowchart showing the operation of the optical pulse generation device and an optical pulse generation method according to the second modification example.

FIG. 21 is a graph showing examples of an initial value set at the 0th circulation after the start of excitation in a simulation.
(a) in FIG. 22 is a graph showing changes in the peak power of an optical pulse for each circulation in a simulation, and (b) in FIG. 22 is a graph showing a relationship between the saturation energy of an optical amplification medium and the peak power of an optical pulse in a simulation.

FIG. 23 is a graph showing a time waveform of an optical pulse generated when the saturation energy is fixed at 600 pJ and a certain random noise is set as an initial value in a simulation. (a) in FIG. 23 shows a time waveform of random noise, which is an initial value, and (b) in FIG. 23 shows a time waveform of an optical pulse generated corresponding to (a) in FIG. 23.

FIG. 24 is a graph showing a time waveform of an optical pulse generated when the saturation energy is fixed at 600 pJ and a random noise different from that in FIG. 23 is set as an initial value in a simulation. (a) in FIG. 24 shows a time waveform of random noise, which is an initial value, and (b) in FIG. 24 shows a time waveform of an optical pulse generated corresponding to (a) in FIG. 24.

FIG. 25 is a graph showing a time waveform of an optical pulse generated when the saturation energy is fixed at 600 pJ and a random noise different from those in FIGS. 23 and 24 is set as an initial value in a simulation. (a) in FIG. 25 shows a time waveform of random noise, which is an initial value, and (b) in FIG. 25 shows a time waveform of an optical pulse generated corresponding to (a) in FIG. 25.

FIG. 26 is a graph showing a time waveform of an optical pulse generated when the saturation energy is fixed at 600 pJ and a random noise different from those in FIGS. 23 to 25 is set as an initial value in a simulation. (a) in FIG. 26 shows a time waveform of random noise, which is an initial value, and (b) in FIG. 26 shows a time waveform of an optical pulse generated corresponding to (a) in FIG. 26.

FIG. 27 is a graph showing a result obtained by performing a simulation based on the configuration of an embodiment with the random noise shown in (a) in FIG. 23 as an initial value. (a) in FIG. 27 shows a time waveform at the 1000th circulation, (b) in FIG. 27 shows a time waveform at the 2000th circulation, and (c) in FIG. 27 shows a time waveform at the 5000th circulation.

FIG. 28 is a graph showing a result obtained by performing a simulation based on the configuration of an embodiment with the random noise shown in (a) in FIG. 24 as an initial value. (a) in FIG. 28 shows a time waveform at the 1000th circulation, (b) in FIG. 28 shows a time waveform at the 2000th circulation, and (c) in FIG. 28 shows a time waveform at the 5000th circulation.

FIG. 29 is a graph showing a result obtained by performing a simulation based on the configuration of an embodiment with the random noise shown in (a) in FIG. 25 as an initial value. (a) in FIG. 29 shows a time waveform at the 1000th circulation, (b) in FIG. 29 shows a time waveform at the 2000th circulation, and (c) in FIG. 29 shows a time waveform at the 5000th circulation.

FIG. 30 is a graph showing a result obtained by performing a simulation based on the configuration of an embodiment with the random noise shown in (a) in FIG. 26 as an initial value. (a) in FIG. 30 shows a time waveform at the 1000th circulation, (b) in FIG. 30 shows a time waveform at the 2000th circulation, and (c) in FIG. 30 shows a time waveform at the 5000th circulation.

FIG. 31 is a graph showing the verification result of the controllability of a time interval between optical pulses in an embodiment, and (a) to (d) in FIG. 31 show cases where the time interval between two optical pulses forming an optical pulse train is set to, respectively, 20 ps, 50 ps, 100 ps, and 150 ps.

FIG. 32 is a graph showing the verification result of the controllability of the number of optical pulses in an embodiment, and (a) to (d) in FIG. 32 show cases where the number of optical pulses forming an optical pulse train is set to, respectively, 1, 2, 3, and 4.

FIG. 33 is a graph showing how the number of optical pulses changes in a simulation.
(a) to (c) in FIG. 34 are graphs showing time waveforms of an optical pulse train laser-oscillating at each stage of change in the number of optical pulses.
(a) to (c) in FIG. 35 are graphs showing time waveforms of an optical pulse train laser-oscillating at each stage of change in the number of optical pulses.
(a) to (c) in FIG. 36 are graphs showing time waveforms of an optical pulse train laser-oscillating at each stage of change in the number of optical pulses.
(a) in FIG. 37 is a graph showing changes in the saturation energy according to the number of circulations, and (b) in FIG. 37 is a graph showing changes in the peak power of an optical pulse according to the number of circulations.

FIG. 38 is a graph showing a time waveform of an optical pulse train including 19 optical pulses generated by a spectral domain modulation type waveform controller.

FIG. 39 is a graph showing changes in a time waveform when the time waveform is controlled multiple times by a pulse shaper in a case where the center wavelengths of two or more optical pulses forming an optical pulse train are the same with each other. (a) in FIG. 39 shows a time waveform after the first waveform control, (b) in FIG. 39 shows a time waveform after the second waveform control, (c) in FIG. 39 shows a time waveform after the third waveform control, and (d) in FIG. 39 shows a time waveform after the fourth waveform control.

FIG. 40 is a graph showing changes in a time waveform when the time waveform is controlled multiple times by a pulse shaper in a case where the center wavelengths of two or more optical pulses forming an optical pulse train are different from each other. (a) in FIG. 40 shows a time waveform after the first waveform control, (b) in FIG. 40 shows a time waveform after the second waveform control, (c) in FIG. 40 shows a time waveform after the third waveform control, and (d) in FIG. 40 shows a time waveform after the fourth waveform control.
(a) to (c) in FIG. 41 are graphs showing three optical pulses having different center wavelengths each other.
(a) to (c) in FIG. 42 are graphs showing time waveforms obtained for each optical pulse as a result of simultaneously circulating the three optical pulses shown in FIG. 41 in an optical resonator in a simulation.

FIG. 43 is a graph showing how the center wavelength of each optical pulse converges.
(a) to (c) in FIG. 44 are graphs showing results obtained by performing waveform control for conversion into three optical pulses having different center wavelengths each other over ten circulations in a simulation.
(a) to (c) in FIG. 45 are graphs showing results obtained by performing waveform control for conversion into three optical pulses having different center wavelengths each other over ten circulations in a simulation.
(a) to (c) in FIG. 46 are graphs showing results obtained by performing waveform control for conversion into three optical pulses having different center wavelengths each other over ten circulations in a simulation.
(a) in FIG. 47 is a graph showing changes in the peak position of each optical pulse, and (b) in FIG. 47 is a graph showing a portion of the 500th to 510th circulations in (a) in FIG. 47 in an enlarged manner.

FIG. 48 is a schematic diagram showing a pulse splitter, which is a combination of splitters and delayers, as an example of a waveform control device.

### DESCRIPTION OF EMBODIMENTS

An optical pulse generation device according to one aspect of the present disclosure includes an optical resonator of mode-locked type, a light source, and a waveform controller. The optical resonator includes an optical amplification medium and generates, amplifies, and outputs laser light. The light source is optically coupled to the optical resonator and supplies excitation light to the optical amplification medium. The waveform controller is arranged in the optical resonator, and controls a time waveform of the laser light within a predetermined period to convert the laser light into an optical pulse train including two or more optical pulses within a period of the optical resonator. The optical resonator amplifies the optical pulse train after the predetermined period and outputs the optical pulse train having amplified as the laser light.

An optical pulse generation method according to one aspect of the present disclosure includes a laser light generation, a waveform control, and an output. In the laser light generation, excitation light is applied to an optical amplification medium in a mode-locked optical resonator to generate and amplify laser light in the optical resonator. In the waveform control, a time waveform of the laser light in the optical resonator is controlled within a predetermined period to convert the laser light into an optical pulse train including two or more optical pulses within a period of the optical resonator. In the output, the optical pulse train is amplified in the optical resonator after the predetermined period and output to an outside of the optical resonator as laser light.

In the mode-locked optical resonator, when the optical amplification medium is excited, an ultrashort optical pulse that is laser light is periodically generated and output. Then, depending on the oscillation conditions such as the intensity of excitation light, two or more ultrashort optical pulses that are temporally close to each other are generated. However, in previous reports, the time interval between two or more ultrashort optical pulses was random, and it was not realized to control the time interval.

On the other hand, in the optical pulse generation device described above, the waveform controller is provided in the mode-locked optical resonator. The waveform controller controls the time waveform of the laser light within a predetermined period to convert the laser light into two or more optical pulses. Similarly, in the optical pulse generation method described above, in the waveform control, the time waveform of the laser light in the optical resonator is controlled within a predetermined period to convert the laser light into an optical pulse train including two or more optical pulses within a period of the optical resonator. In these cases, if an appropriate amount of excitation light continues to be applied to the optical amplification medium, the optical pulse train is amplified in the optical resonator and output as the laser light. The number of optical pulses included in the laser light matches the number of optical pulses in the original optical pulse train. The time interval between the optical pulses included in the laser light matches the time interval between the optical pulses in the original optical pulse train, or matches the time interval theoretically calculated from the time interval between the optical pulses in the original optical pulse train. Therefore, according to the above configuration, it is possible to stably output laser light, which is an optical pulse train including two or more temporally close ultrashort optical pulses, with a predetermined number of pulses and a predetermined time interval with good reproducibility.

In the optical pulse generation device, the number of the two or more optical pulses and a time interval between the two or more optical pulses may be variable. In the optical pulse generation method, after the output, the waveform control and the output may be repeated by changing at least one of the number of two or more optical pulses and the time interval between the two or more optical pulses. As described above, in burst laser processing or the like, the number of pulses in a pulse train and the time interval between the pulses are important parameters. The ultrashort pulse train with a time interval between optical pulses of less than 10 nanoseconds can also be generated by using, for example, an interferometer. However, in the method using an interferometer, it takes time to change the number of pulses in a pulse train and the time interval between the pulses, and frequent changes of these lead to a decrease in throughput. Therefore, the method using an interferometer is suitable for repeating the same processing on a predetermined object, but is practically unsuitable for repeating processing while optimizing the processing conditions according to various materials and shapes of objects. On the other hand, in the above-described optical pulse generation device and optical pulse generation method, since the light intensity of the optical pulse train before amplification needs only to be larger than the noise, it is easy to make variable the number of pulses and the time interval between pulses of the optical pulse train generated in the waveform controller. Therefore, it is possible to easily repeat processing while optimizing the processing conditions according to various materials and shapes of objects.

When the number of two or more optical pulses is variable, the light intensity of the excitation light may be variable, and the light intensity of the excitation light may be increased as the number of optical pulses forming the optical pulse train increases. Similarly, when repeating the waveform control and the output while changing the number of two or more optical pulses, the light intensity of the excitation light applied to the optical amplification medium may be increased as the number of optical pulses forming the optical pulse train increases in the output. If the excitation light intensity is too small relative to the number of optical pulses, some optical pulses may disappear without being amplified sufficiently. If the excitation light intensity is too large relative to the number of optical pulses, a part of noise unrelated to the optical pulse train may be amplified to cause an unintended increase in the number of optical pulses. By increasing the light intensity of the excitation light as the number of optical pulses forming the optical pulse train increases, the excitation light having an appropriate light intensity according to the number of optical pulses can be applied to the optical amplification medium.

Before repeating the waveform control after the output, the number of optical pulses may be reduced to one by changing the light intensity of the excitation light applied to the optical amplification medium from a magnitude corresponding to the number of optical pulses forming the optical pulse train to a magnitude corresponding to one optical pulse, and the one optical pulse may be amplified as the laser light in the optical resonator. In this manner, by reducing the number of optical pulses to one before generating two or more optical pulses in the waveform control, the number of optical pulses can be stably changed. According to the inventors' simulation, when the light intensity of the excitation light is reduced from the light intensity corresponding to two or more optical pulses to the light intensity corresponding to a single optical pulse, one of the two or more optical pulses is left and the other optical pulses disappear.

The waveform controller may include: an optical path switch having at least one input port and at least two output ports; and a waveform control device that controls the time waveform of the laser light to convert the laser light into the optical pulse train. The optical resonator may include a first optical path, a second optical path, and a third optical path. The first optical path has one end optically coupled to the one input port of the optical path switch. The second optical path has one end optically coupled to one of the output ports of the optical path switch and the other end optically coupled to the other end of the first optical path. The third optical path has one end optically coupled to the other one of the output ports of the optical path switch and the other end optically coupled to the other end of the first optical path. The optical amplification medium may be arranged on the first optical path. The waveform control device may be arranged on the third optical path. The optical path switch may select the third optical path in the predetermined period and select the second optical path in other periods. In this case, it can be easily realized that the waveform controller controls the time waveform of the laser light only within the predetermined period.

The optical pulse generation device may further include: a photodetector that is optically coupled to the optical resonator and detects light output from the optical resonator to generate an electrical detection signal; and a switch controller that controls the optical path switch. The switch controller may determine a timing for selecting the third optical path based on the detection signal from the photodetector. In this case, the switching timing of the optical path in the optical path switch can be stably controlled.

The optical pulse generation device may include a polarization switch and a waveform control device. The polarization switch is arranged in the optical resonator to control a polarization plane of the laser light. The waveform control device controls the time waveform of the laser light to convert the laser light into the optical pulse train when the laser light has a first polarization plane and does not control the time waveform of the laser light when the laser light has a second polarization plane different from the first polarization plane. The polarization switch may set the polarization plane of the laser light to the first polarization plane in the predetermined period and set the polarization plane of the laser light to the second polarization plane in other periods. In this case, it can be easily realized that the waveform controller controls the time waveform of the laser light only within the predetermined period.

The waveform controller may further include: a photodetector that is optically coupled to the optical resonator and detects light output from the optical resonator to generate an electrical detection signal; and a switch controller that controls the polarization switch. The switch controller may determine a timing for setting the polarization plane of the laser light to the first polarization plane based on the detection signal from the photodetector. In this case, the switching timing of the polarization plane in the polarization switch can be stably controlled.

The optical resonator may generate the laser light as a single pulse before the predetermined period. The waveform controller may include a spectral element, a spatial light modulator, and an optical system. The spectral element diffracts the laser light. The spatial light modulator performs modulation for converting the laser light into the optical pulse train for at least one of an intensity spectrum and a phase spectrum of the laser light after spectral diffraction and outputs modulated light. The optical system condenses the modulated light and outputs the optical pulse train. For example, such a waveform controller can stably generate the optical pulse train, which includes two or more temporally close ultrashort optical pulses, with a predetermined number of pulses and a predetermined time interval.

The optical resonator may generate the laser light as a continuous wave before the predetermined period. The waveform controller may convert the laser light into the optical pulse train by modulating an intensity of the laser light. For example, such a waveform controller can also stably generate the optical pulse train, which includes two or more temporally close ultrashort optical pulses, with a predetermined number of pulses and a predetermined time interval.

Center wavelengths of the two or more optical pulses immediately after being converted by the waveform controller or the waveform control may be the same with each other. In this case, the time interval between the optical pulses at the beginning of conversion can be maintained without being affected by chromatic dispersion in the optical resonator.

Center wavelengths of the two or more optical pulses immediately after being converted by the waveform controller or the waveform control may be different from each other. In this case, the time interval between the optical pulses gradually increases or decreases after conversion due to the influence of chromatic dispersion in the optical resonator. According to the inventors' simulation, the center wavelength of each optical pulse gradually converges to one wavelength with the elapse of time. Therefore, the time interval between the optical pulses does not increase beyond a certain magnitude or does not decrease below a certain magnitude. In addition, the magnitude of the time interval between the optical pulses can be calculated in advance by using parameters such as chromatic dispersion. Therefore, it is possible to output the laser light having a pulse interval larger or smaller than the pulse interval that can be realized in the waveform controller and the waveform control.

The time waveform of the laser light may be controlled only once within the predetermined period. Alternatively, the time waveform of the laser light may be controlled multiple times within the predetermined period. In particular, when the center wavelengths of two or more optical pulses immediately after conversion are different from each other, the time waveform of the laser light is controlled multiple times within a predetermined period, so that the time interval between the optical pulses can be increased during the period. Therefore, it is possible to output laser light with a wider pulse interval.

A time interval between the two or more optical pulses may be 10 femtoseconds or more and 10 nanoseconds or less.

Hereinafter, embodiments of an optical pulse generation device and an optical pulse generation method will be described in detail with reference to the accompanying diagrams. In the description of the diagrams, the same elements are denoted by the same reference numerals, and the repeated description thereof will be omitted. The invention is not limited to these examples, but is defined by the claims, and is intended to include all modifications within the meaning and scope equivalent to the claims. In the following description, unless otherwise specified, the time interval between optical pulses means an interval at which the light intensity of the optical pulse reaches its peak.

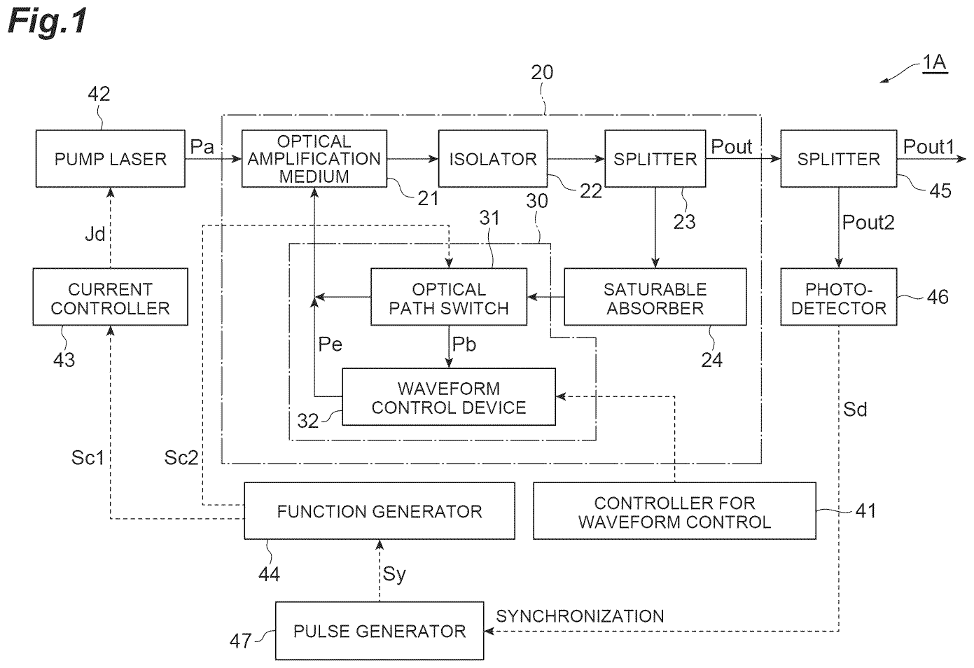

FIG. 1 is a block diagram showing the configuration of an optical pulse generation device according to an embodiment of the present disclosure. In FIG. 1, solid arrows indicate optical paths (optical fibers or spatial optical paths) and dotted arrows indicate electrical wiring. As shown in FIG. 1, an optical pulse generation device 1A of the present embodiment includes a mode-locked optical resonator 20 and a waveform controller 30.

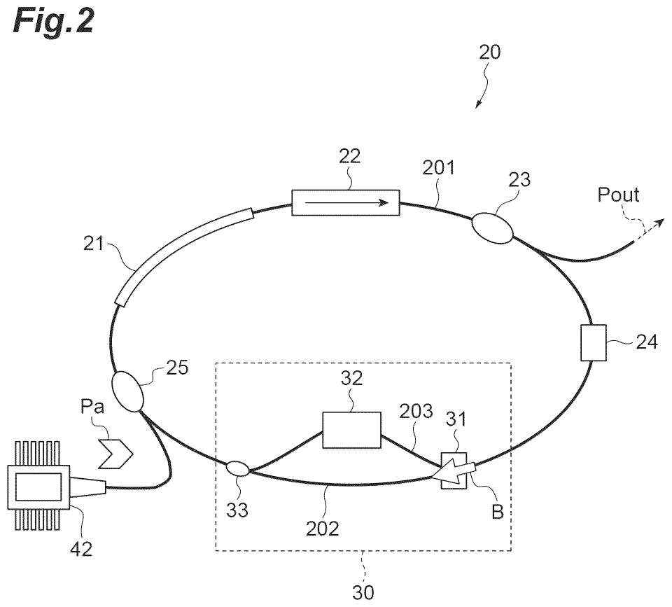

The optical resonator 20 is an optical system (mode-locked laser) that generates and amplifies laser light and outputs the amplified laser light. FIG. 2 is a schematic diagram of the optical resonator 20. FIG. 2 shows a ring resonator as an example of the optical resonator 20. As the optical resonator 20, instead of the ring resonator, for example, a figure-eight laser resonator, a figure-9 laser resonator, and a Fabry-Perot resonator may be adopted. The optical resonator 20 of the present embodiment is configured to include an optical amplification medium 21, an isolator 22, a splitter 23, and a saturable absorber 24. The optical resonator 20 includes a first optical path 201, a second optical path 202, and a third optical path 203. The first optical path 201, the second optical path 202, and the third optical path 203 are, for example, optical fibers.

The optical amplification medium 21 is arranged on the first optical path 201, and is excited by receiving excitation light (pump light) Pa supplied from the outside of the optical resonator 20. The optical amplification medium 21 amplifies light, which circulates in the optical resonator 20 and has a different wavelength from the excitation light Pa, when the light passes through the optical amplification medium 21. The optical amplification medium 21 is, for example, erbium-doped fiber, ytterbium-doped fiber, thulium-doped fiber, or neodymium-doped YAG crystal. The light circulating in the optical resonator 20 oscillates while being amplified by the optical amplification medium 21 to become laser light.

The saturable absorber 24 is an element that performs mode-locking by intensity-dependent absorption change. The saturable absorber 24 is arranged on the first optical path 201 together with the optical amplification medium 21. The saturable absorber 24 first absorbs the laser light generated in the optical resonator 20 until it is saturated, and increases the transmittance for the laser light incident after saturation compared with that before saturation. Then, the saturable absorber 24 returns to the unsaturated state again and reduces the transmittance for the laser light. As a result, ultrashort pulsed laser light is periodically generated. The saturable absorber 24 is, for example, a carbon nanotube or a semiconductor saturable absorber mirror (SESAM). As a method for mode locking, instead of the method using the saturable absorber 24, for example, nonlinear polarization rotation, nonlinear phase shift, or self-mode locking by the optical Kerr effect (Ker lens mode locking) may be adopted.

The isolator 22 is arranged on the first optical path 201 to prevent the light circulating in the optical resonator 20 from traveling backward. The splitter 23 is arranged on the first optical path 201, and splits the laser light generated in the optical resonator 20 and outputs laser light Pout, which is a part of the laser light, from one output port. The splitter 23 may be, for example, a fiber coupler or a beam splitter.

The waveform controller 30 is arranged inside the optical resonator 20. The waveform controller 30 controls the time waveform of single-pulse ultrashort pulsed laser light within a predetermined period. The waveform controller 30 converts the single-pulse ultrashort pulsed laser light into an optical pulse train including two or more ultrashort optical pulses within the period of the optical resonator 20. The predetermined period is, for example, a time required for the optical pulse to circulate once in the optical resonator 20. Alternatively, the predetermined period is a time required for the optical pulse to circulate in the optical resonator 20 multiple times, for example, 10 times or less. The length of the predetermined period depends on the optical path length of the optical resonator 20. After a predetermined period, the optical resonator 20 amplifies the optical pulse train and outputs the amplified optical pulse train as laser light. The waveform controller 30 of the present embodiment is configured to include an optical path switch 31, a waveform control device 32, and a coupler 33. The coupler 33 is not shown in FIG. 1.

The optical path switch 31 has at least one input port and at least two output ports. The end of the first optical path 201 is optically coupled to the input port of the optical path switch 31. The tip of the second optical path 202 is optically coupled to one output port of the optical path switch 31. The tip of the third optical path 203 is optically coupled to another output port of the optical path switch 31. The coupler 33 has at least two input ports and at least one output port. The end of the second optical path 202 is optically coupled to one input port of the coupler 33. The end of the third optical path 203 is optically coupled to another input port of the coupler 33. The output port of the coupler 33 is optically coupled to the tip of the first optical path 201. The optical path switch 31 selects either one of the second optical path 202 and the third optical path 203 as the traveling path of the laser light arriving from the first optical path 201. The optical path switch 31 selects the third optical path 203 in a predetermined period, and selects the second optical path 202 in the other periods. The optical path switch 31 can be, for example, a combination of an electro-optic modulator (EO modulator) and a polarizing beam splitter, an acousto-optic modulator (AO modulator), or a Mach-Zehnder optical modulator.

The waveform control device 32 is arranged on the third optical path 203. The waveform control device 32 controls the time waveform of the laser light to convert the laser light into an optical pulse train including two or more ultrashort optical pulses within the period of the optical resonator 20. The center wavelengths of the two or more optical pulses immediately after being converted by the waveform control device 32 may be the same or may be different from each other. The intensity of each optical pulse forming the optical pulse train needs only to be larger than the noise in the optical resonator 20.

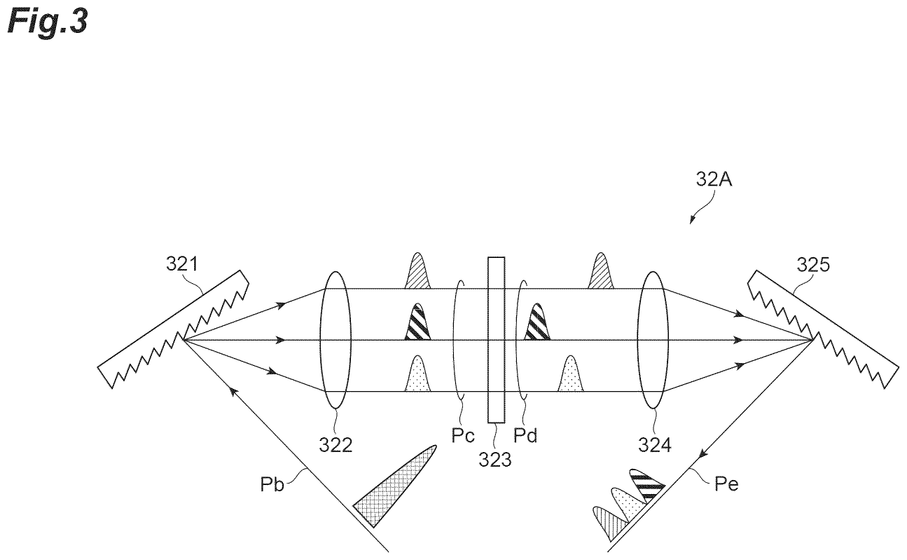

FIG. 3 is a diagram showing a configuration example of a pulse shaper 32A as an example of the waveform control device 32. The pulse shaper 32A has a diffraction grating 321, a lens 322, a spatial light modulator (SLM) 323, a lens 324, and a diffraction grating 325. The diffraction grating 321 is a spectral element in the present embodiment, and is optically coupled to another output port of the optical path switch 31 through the third optical path 203. The SLM 323 is optically coupled to the diffraction grating 321 through the lens 322. The diffraction grating 321 spatially separates a plurality of wavelength components included in ultrashort pulsed laser light Pb for each wavelength. As the spectral element, another optical component such as a prism may be used instead of the diffraction grating 321.

The ultrashort pulsed laser light Pb is obliquely incident on the diffraction grating 321 to be dispersed into a plurality of wavelength components. Light Pc including a plurality of wavelength components is condensed for each wavelength component by the lens 322, so that the image is formed on the modulation surface of the SLM 323. The lens 322 may be a convex lens formed of a light transmissive member, or may be a concave mirror having a concave light reflecting surface.

The SLM 323 modulates the phases of the plurality of wavelength components output from the diffraction grating 321 so that the phases of the plurality of wavelength components are shifted from each other, in order to convert the ultrashort pulsed laser light Pb into an optical pulse train Pe. Therefore, the SLM 323 receives a control signal from a controller for waveform control 41 shown in FIG. 1 and simultaneously performs phase spectrum modulation and intensity spectrum modulation of the ultrashort pulsed laser light Pb. The SLM 323 may perform only the phase spectrum modulation or only the intensity spectrum modulation. The SLM 323 is, for example, of the phase modulation type. In one embodiment, the SLM 323 is of the LCOS (Liquid crystal on silicon) type. Although the transmissive SLM 323 is shown in the diagram, the SLM 323 may be reflective. In this case, the diffraction grating 321 and the diffraction grating 325 may be configured by a common diffraction grating, and the lens 322 and the lens 324 may be configured by a common lens.

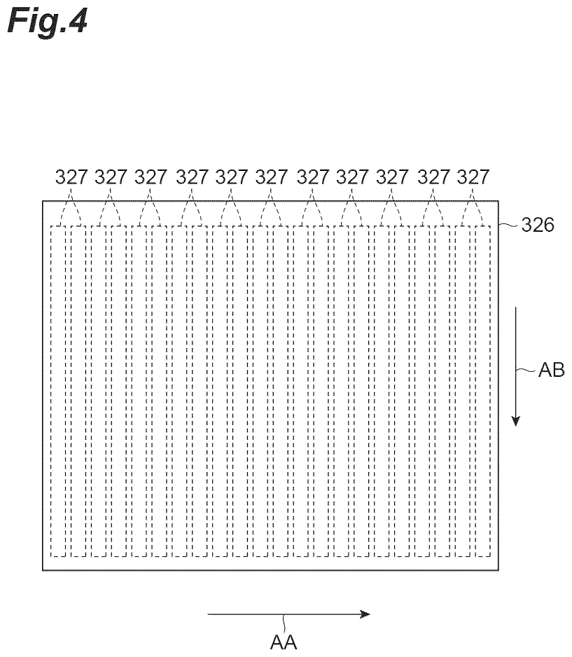

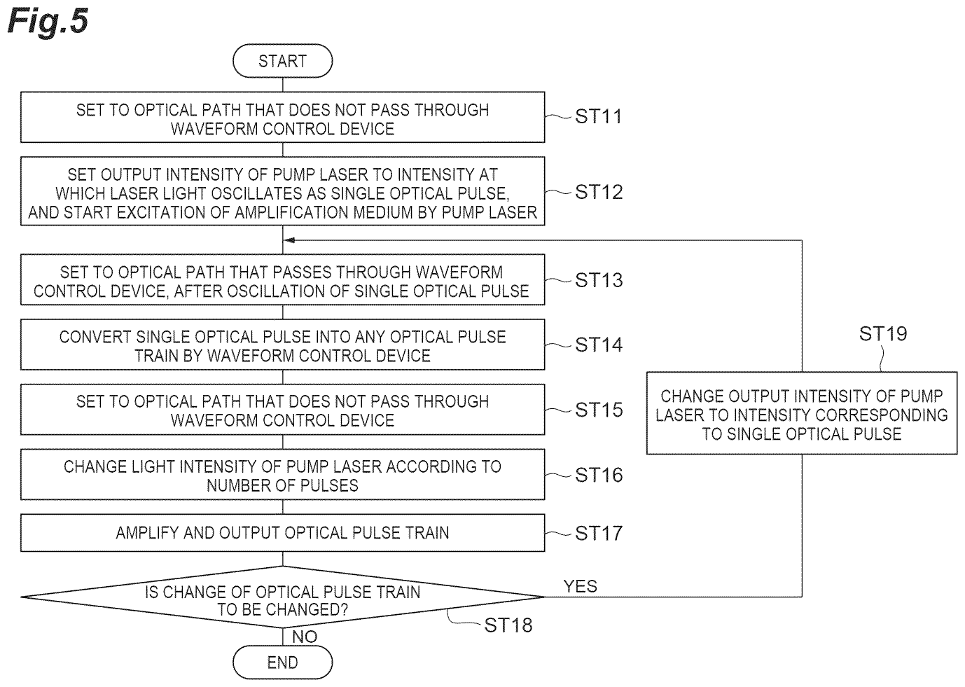

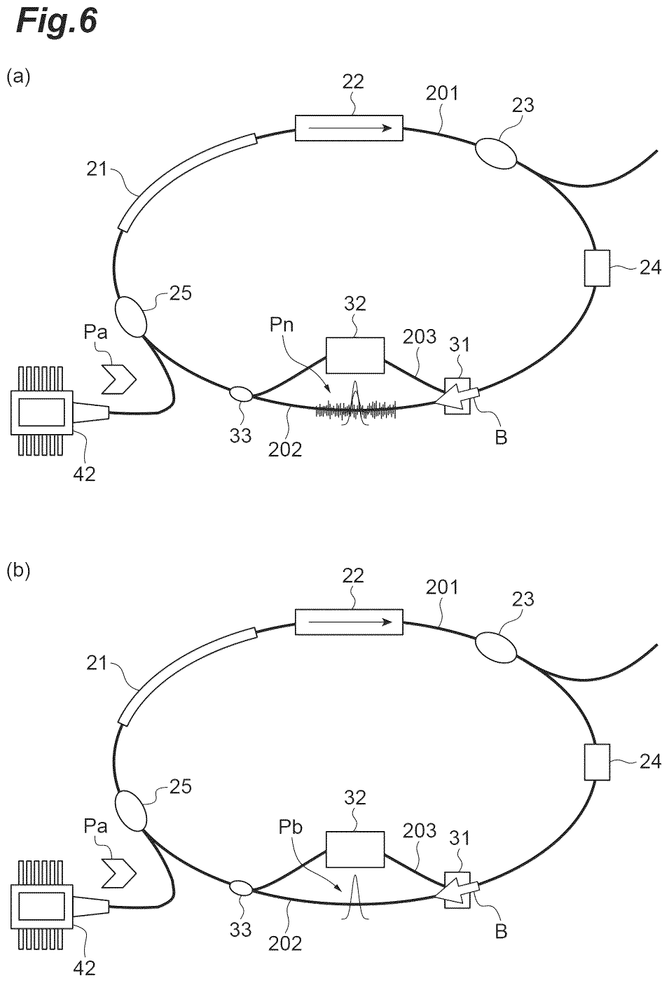

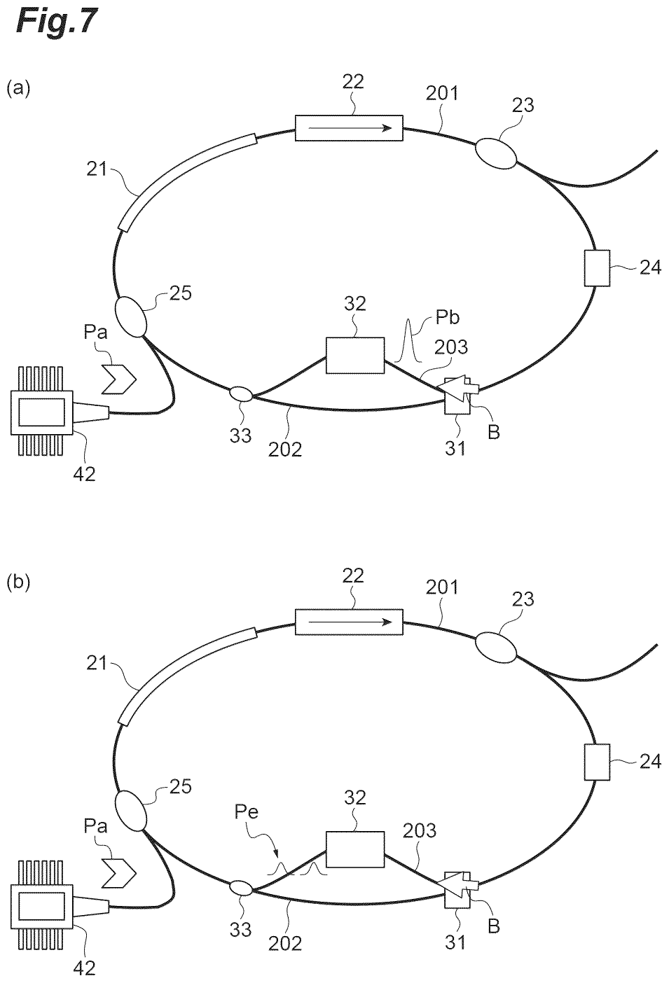

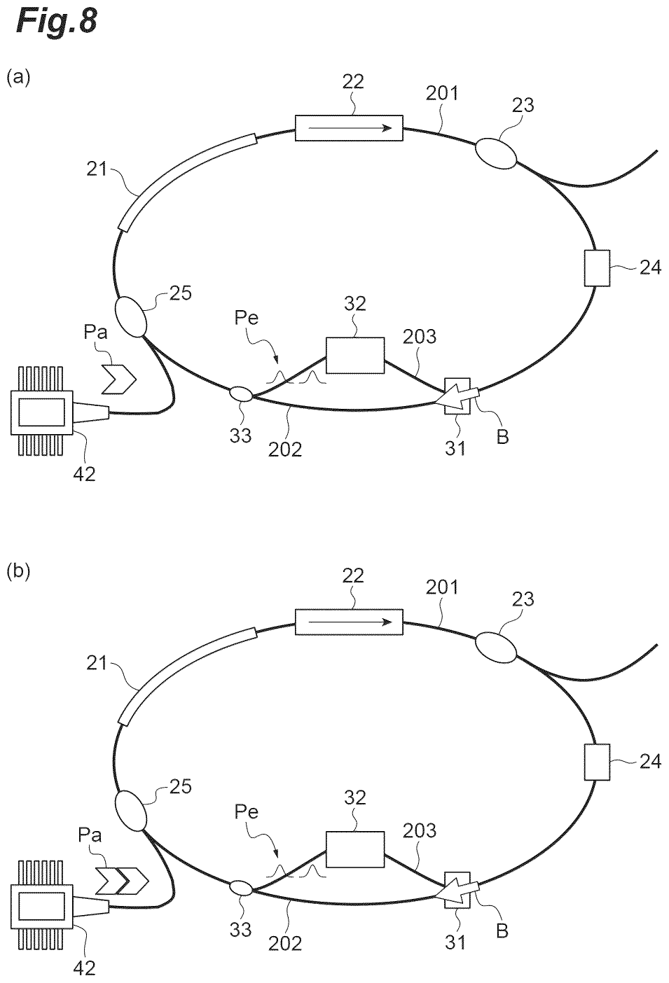

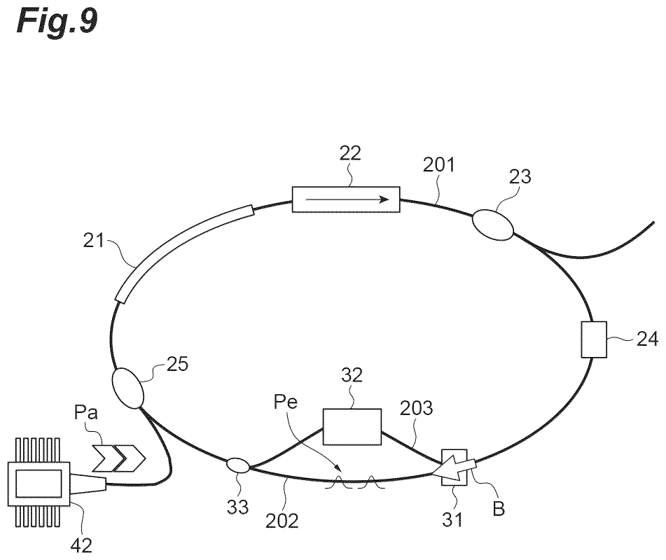

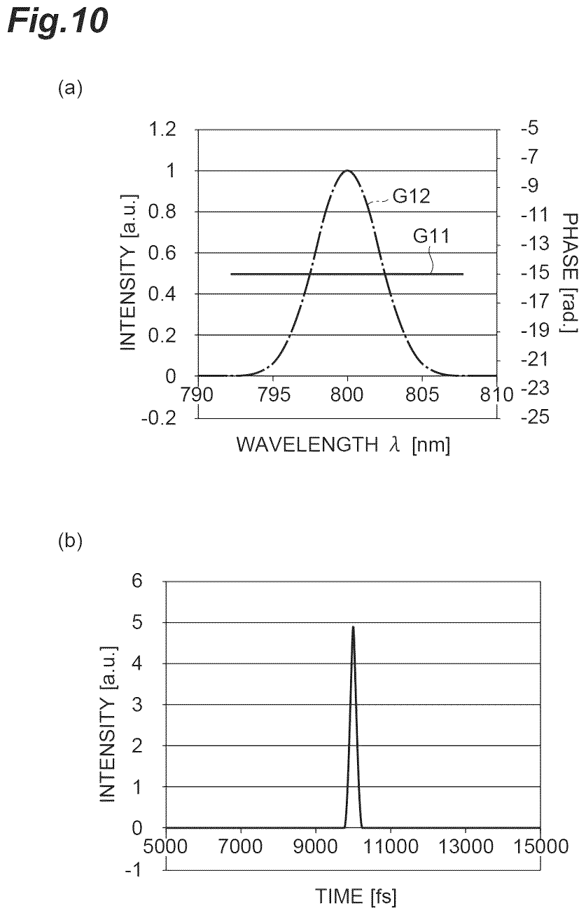

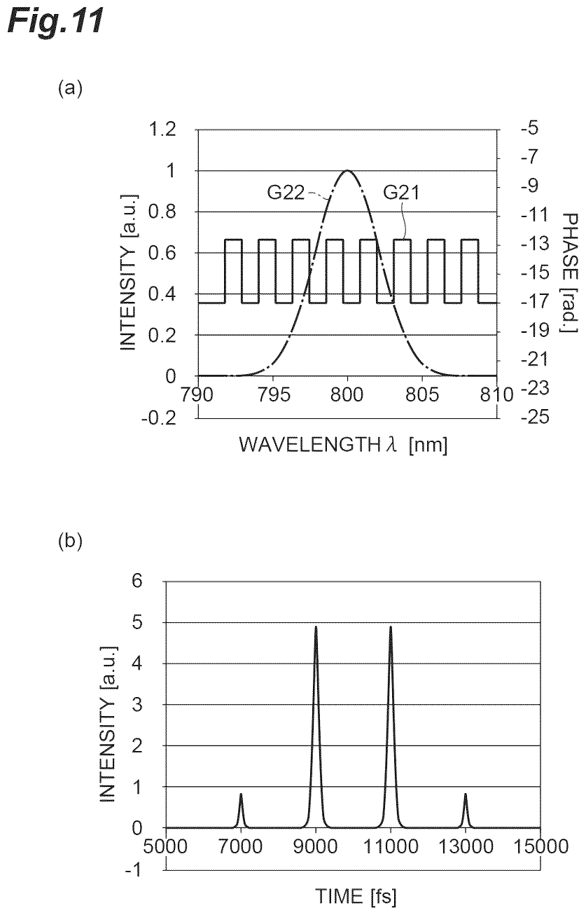

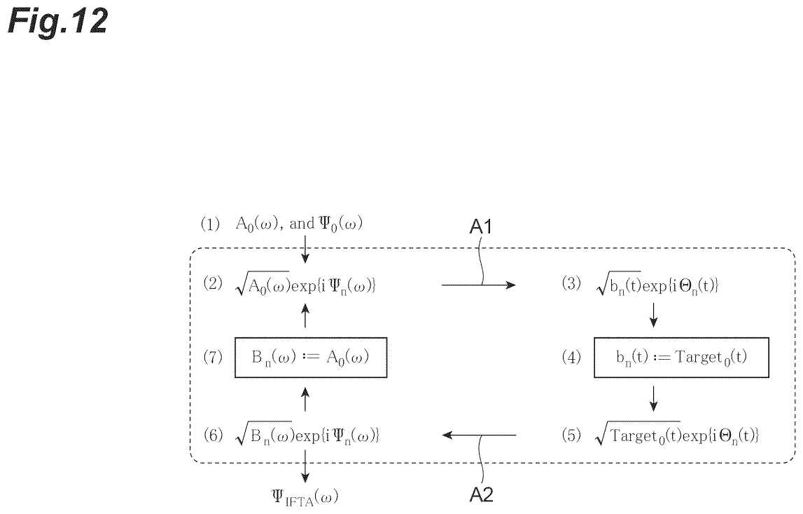

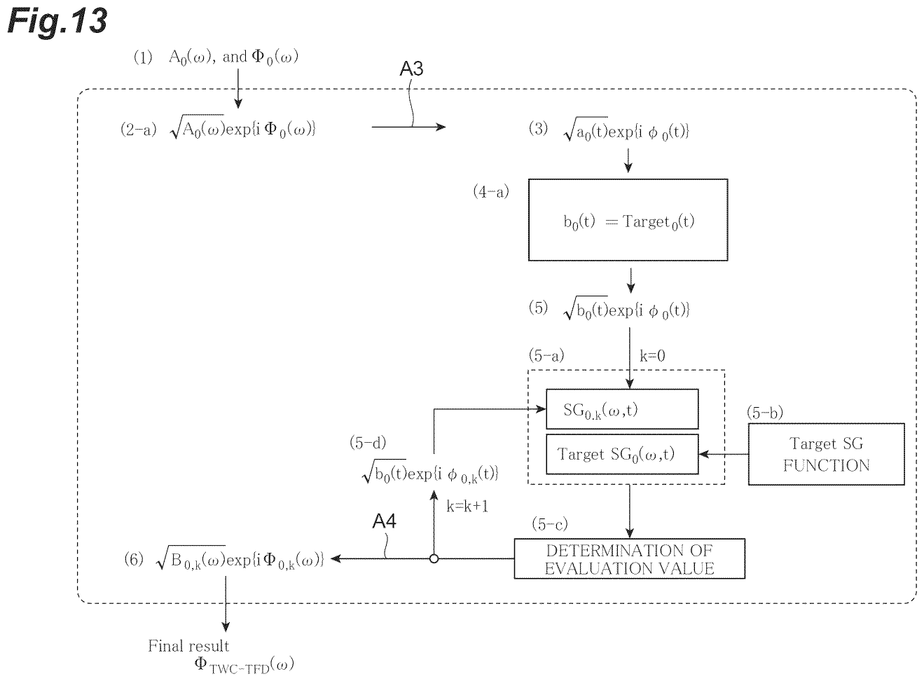

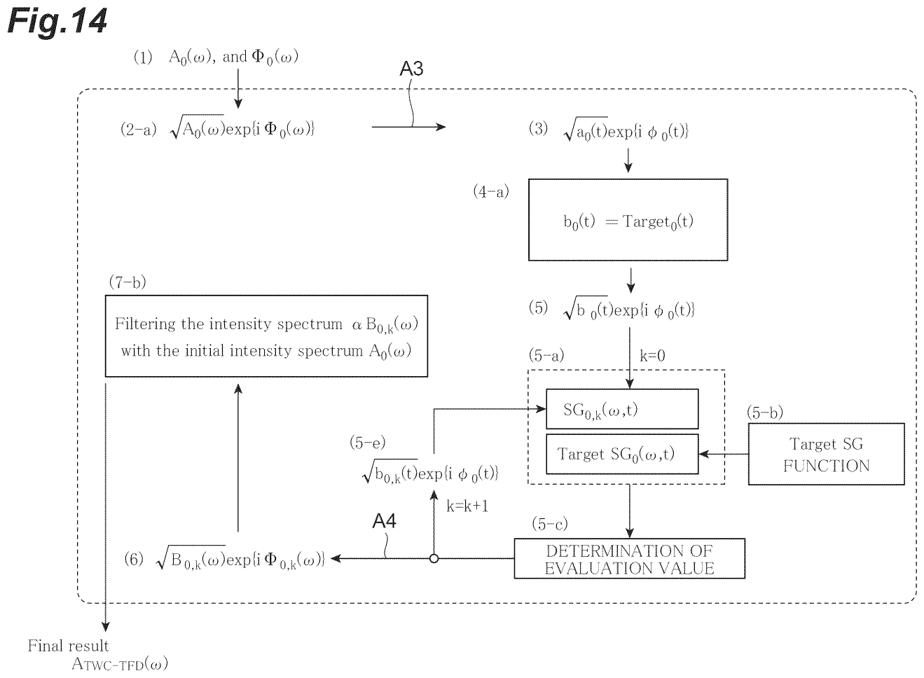

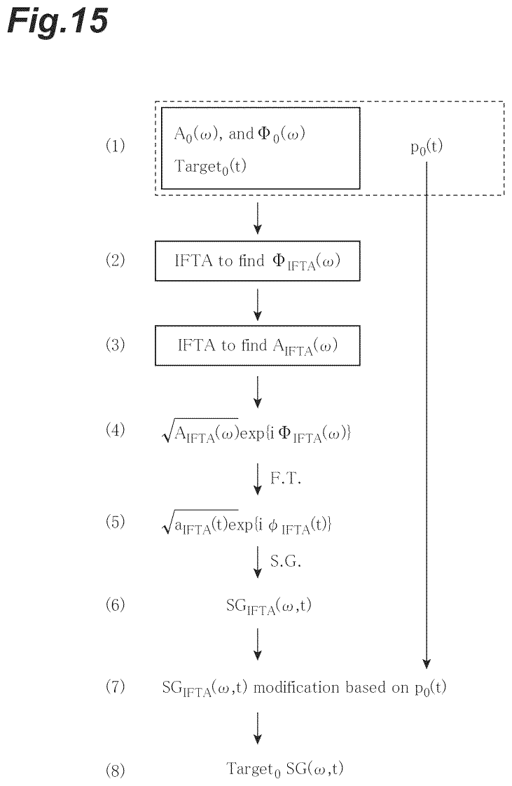

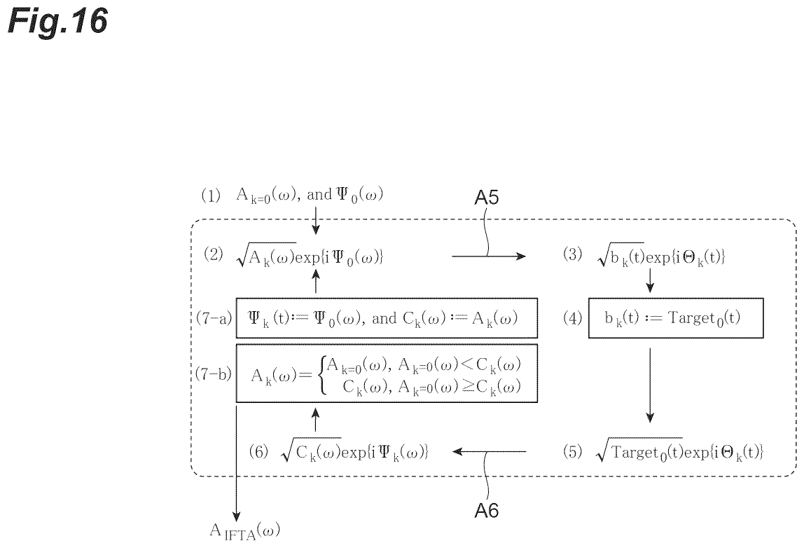

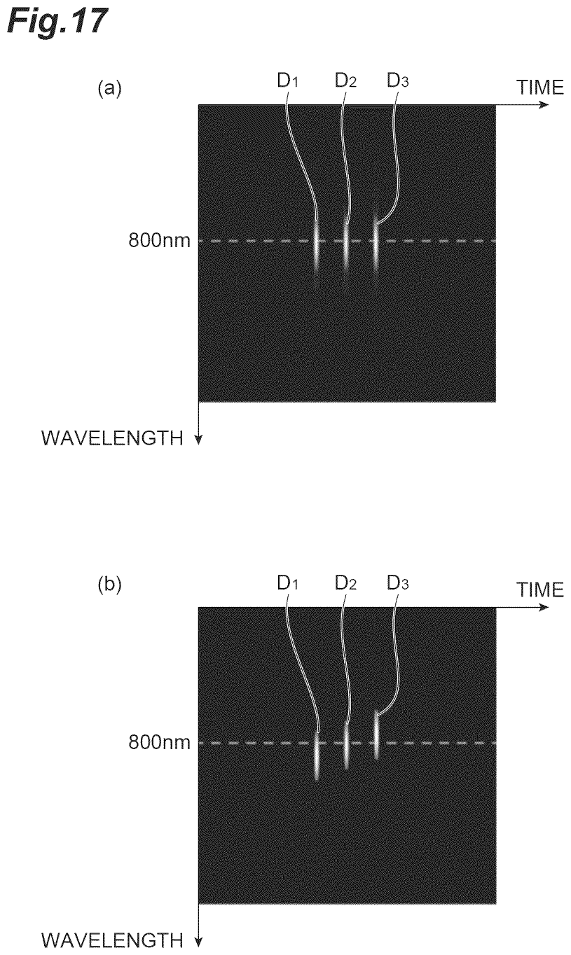

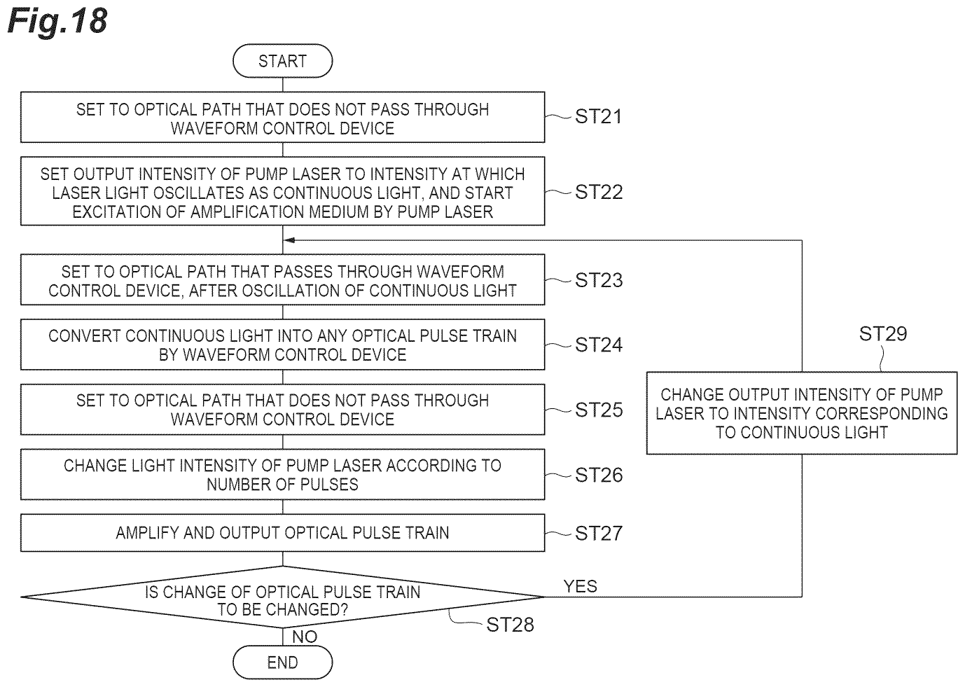

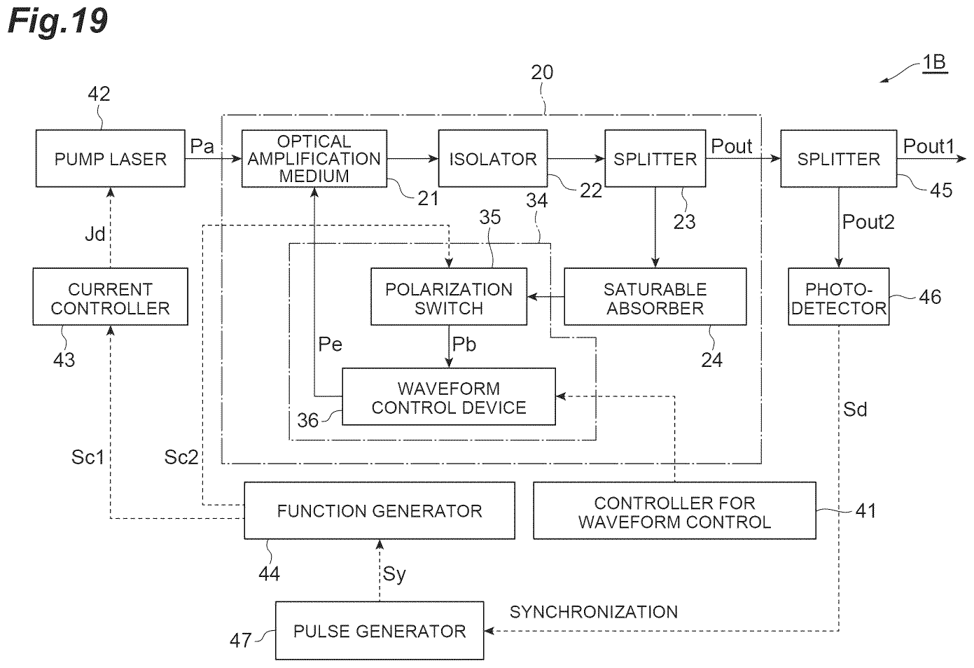

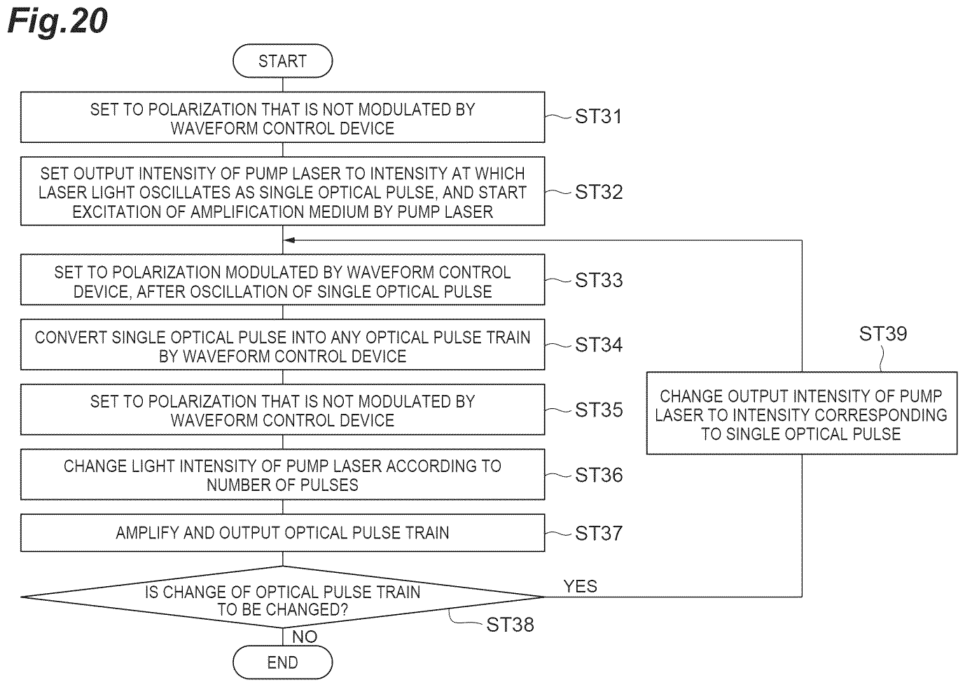

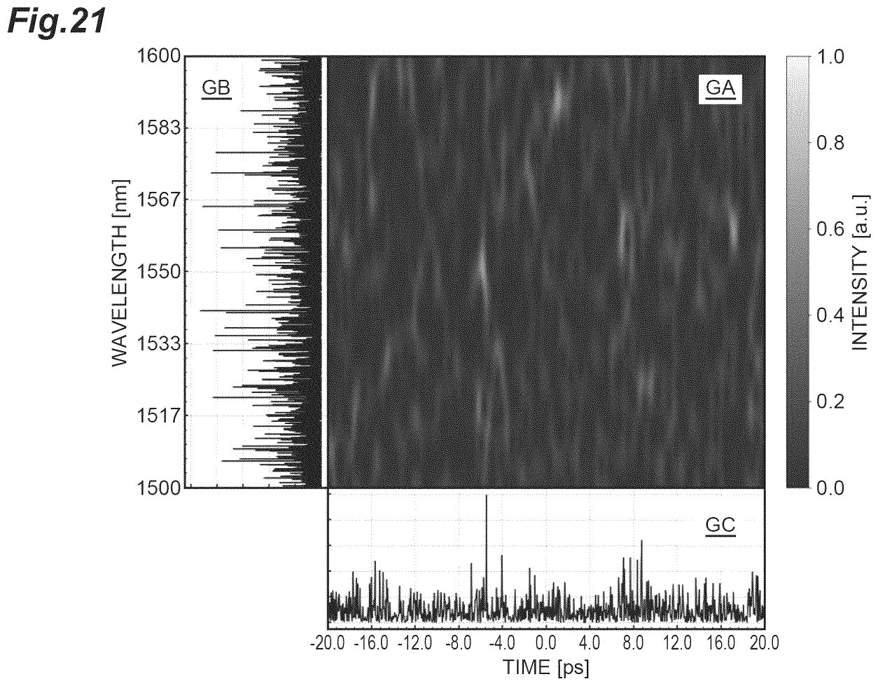

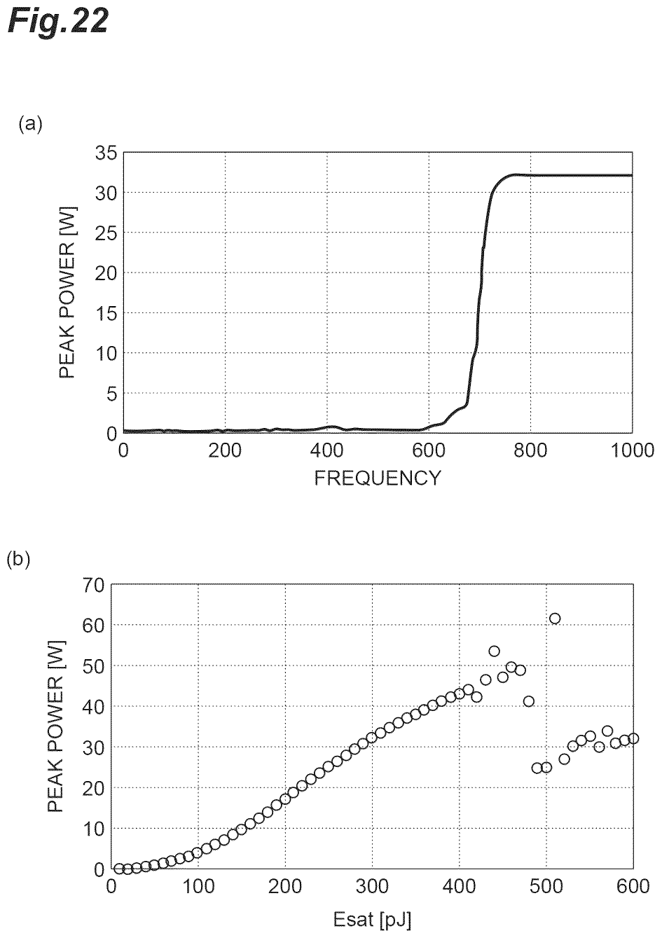

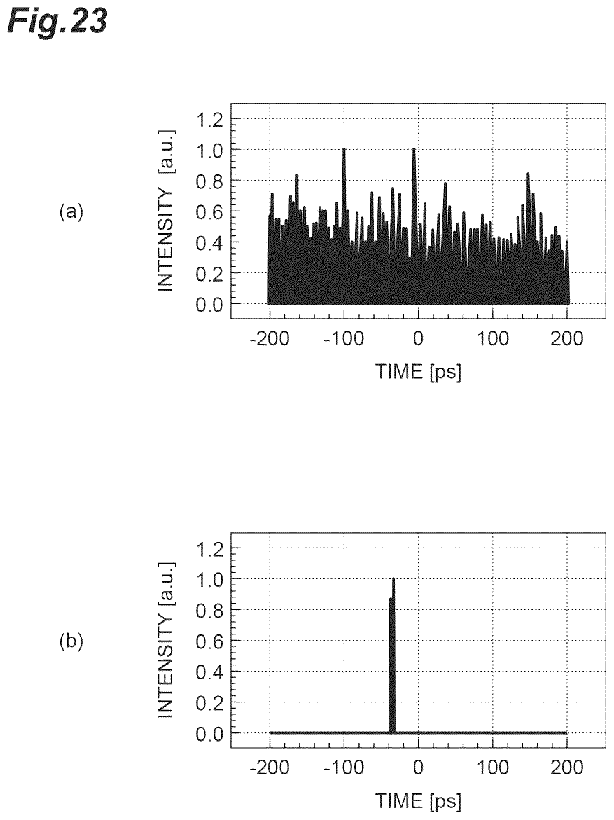

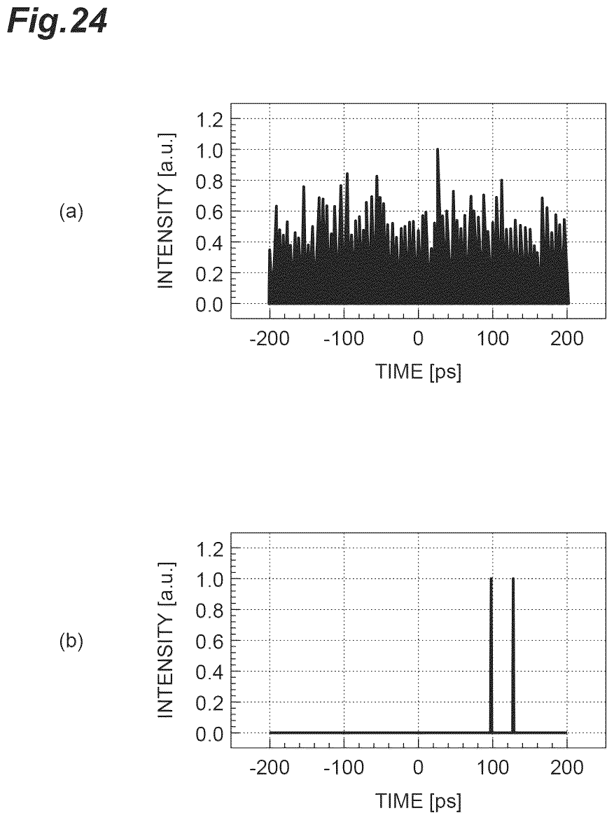

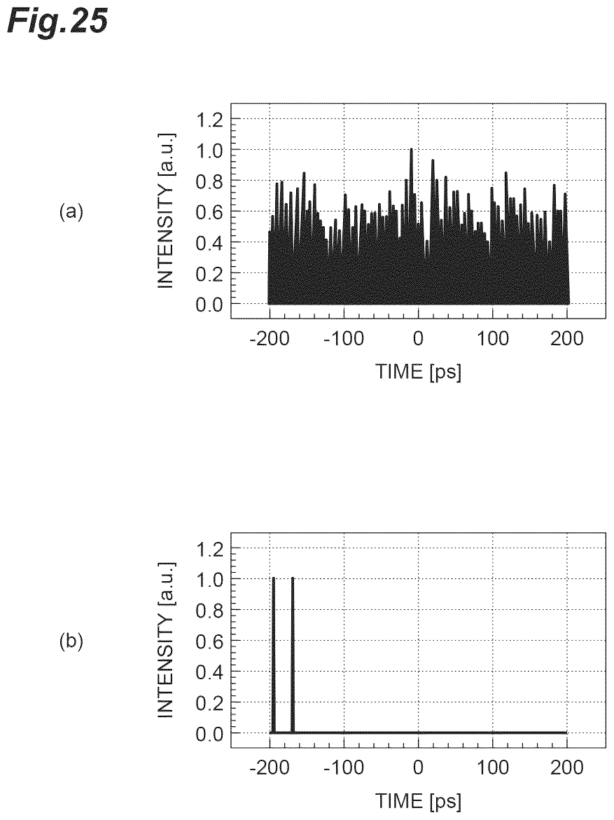

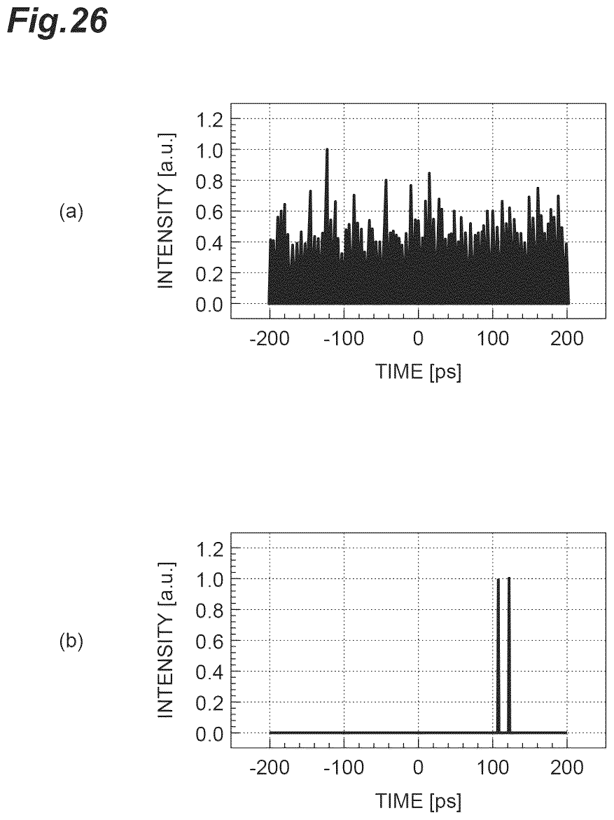

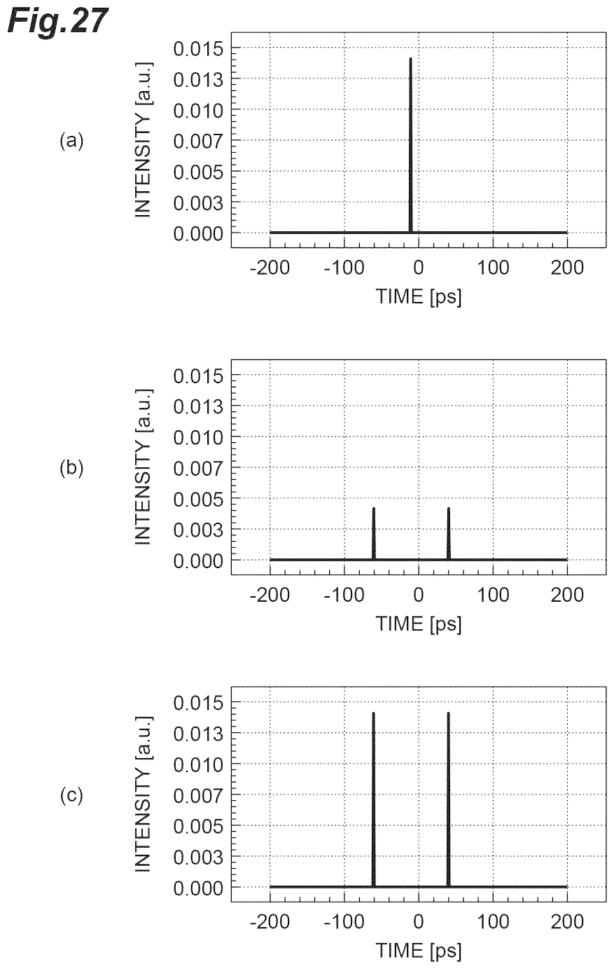

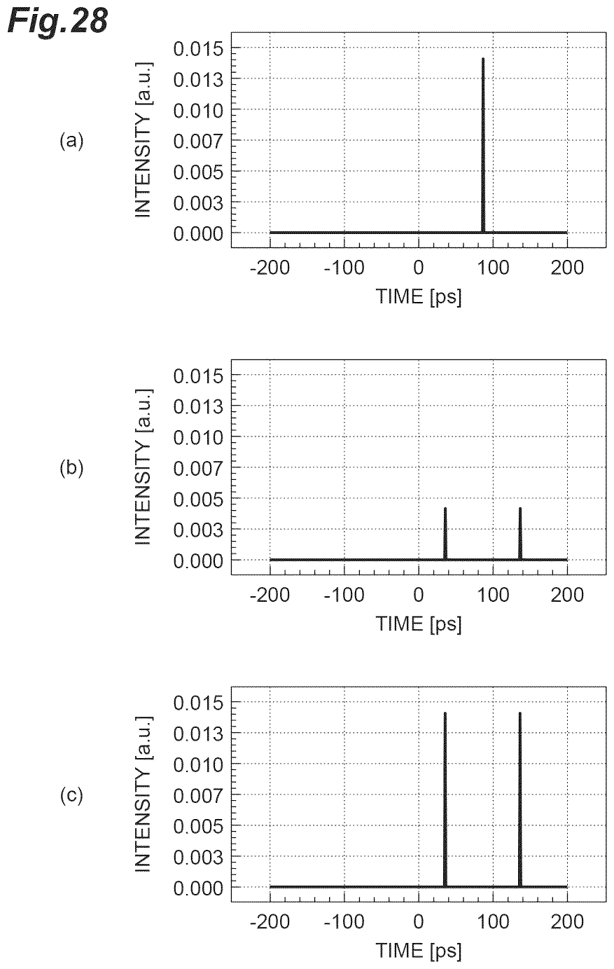

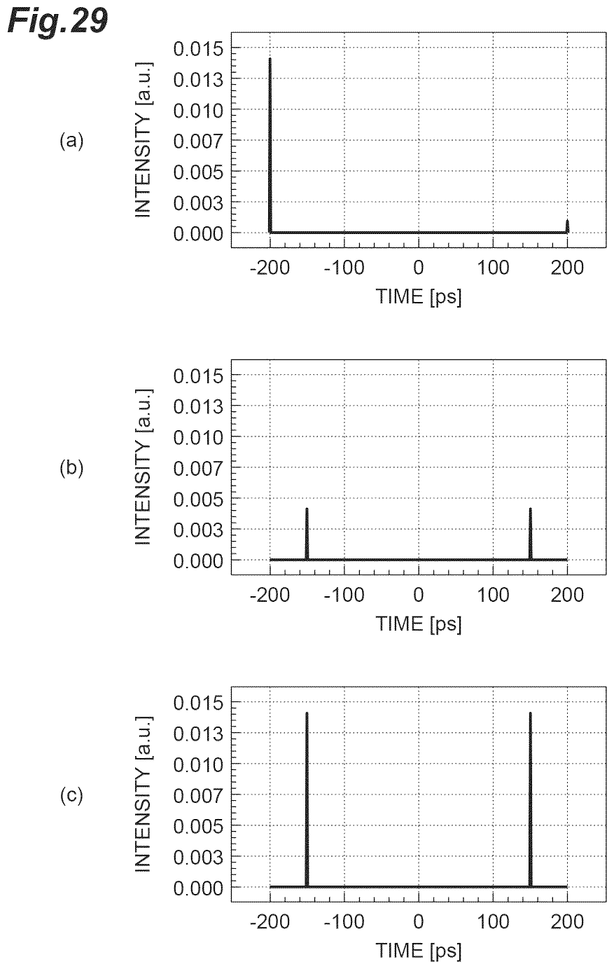

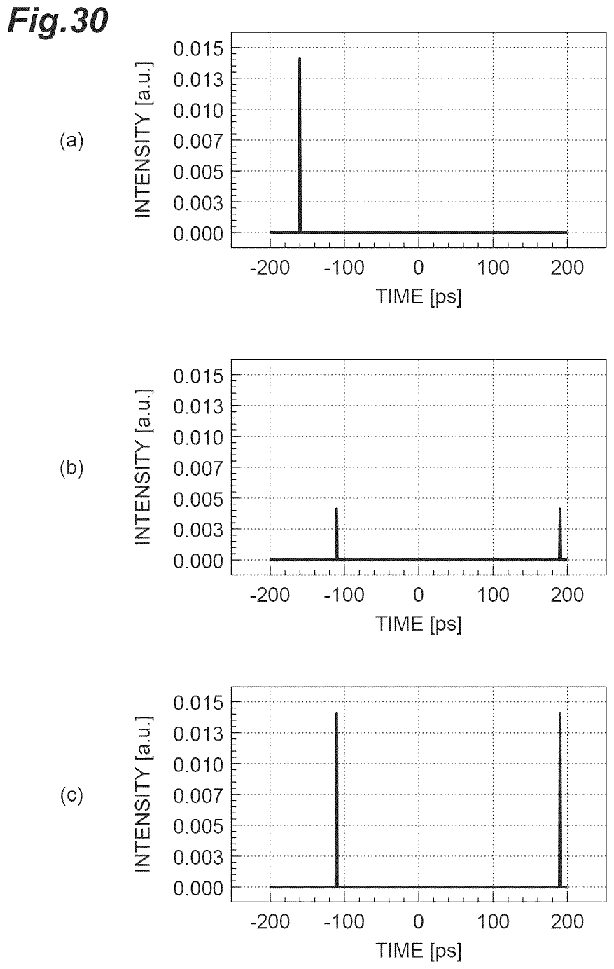

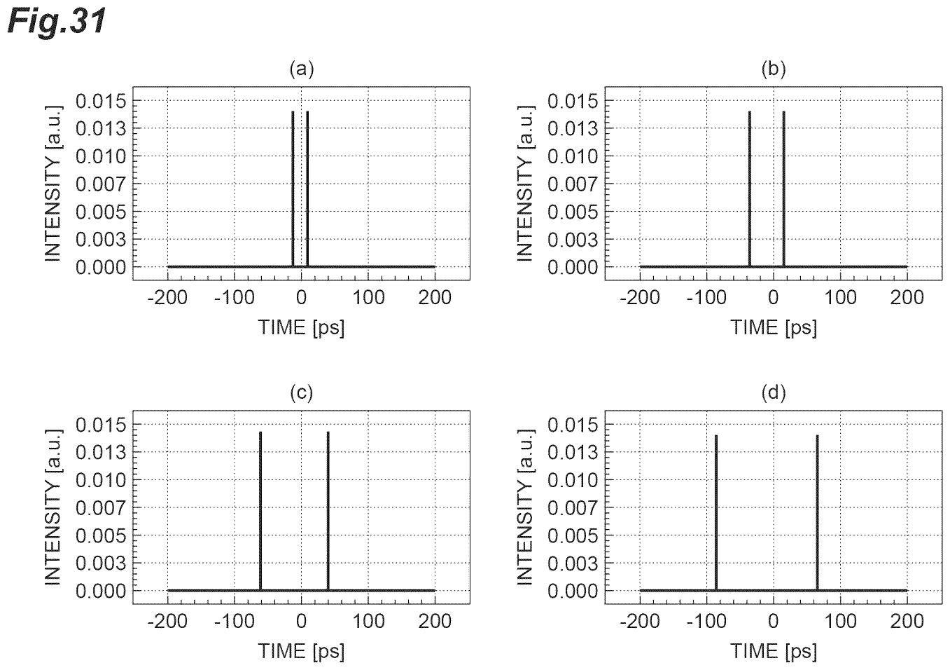

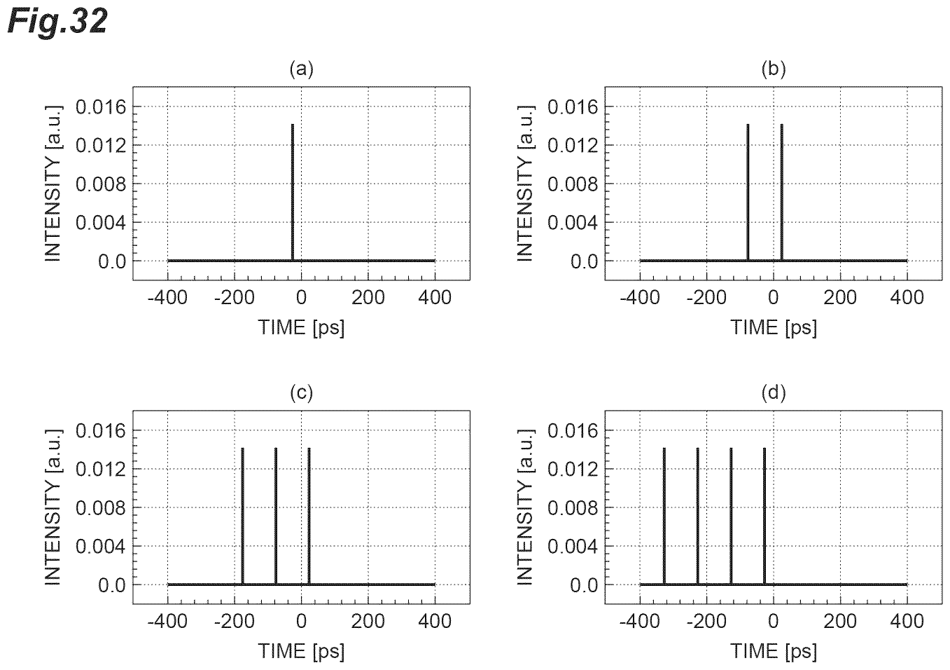

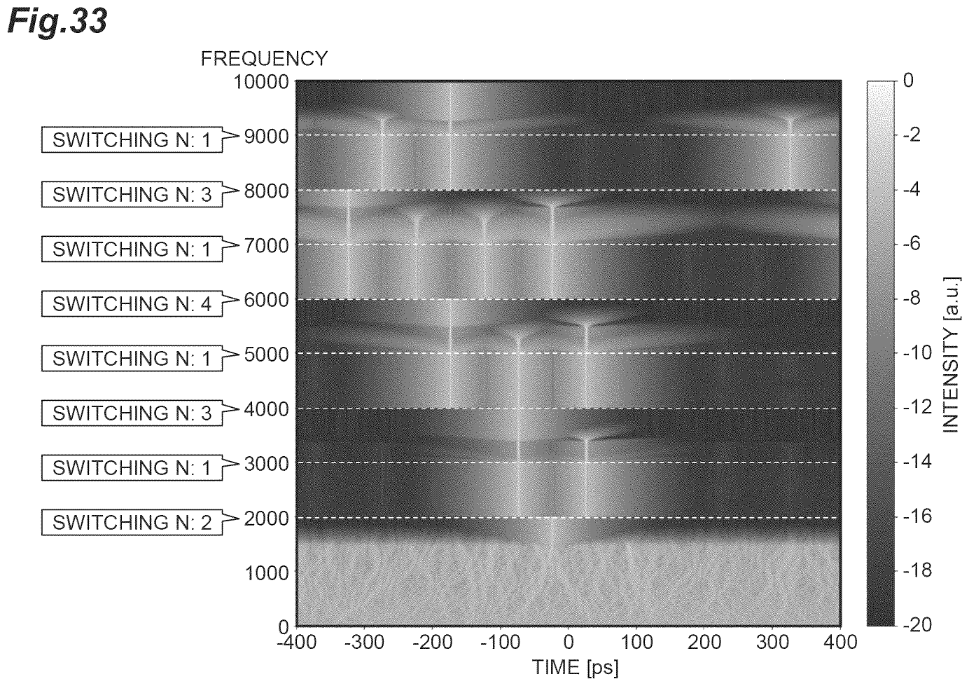

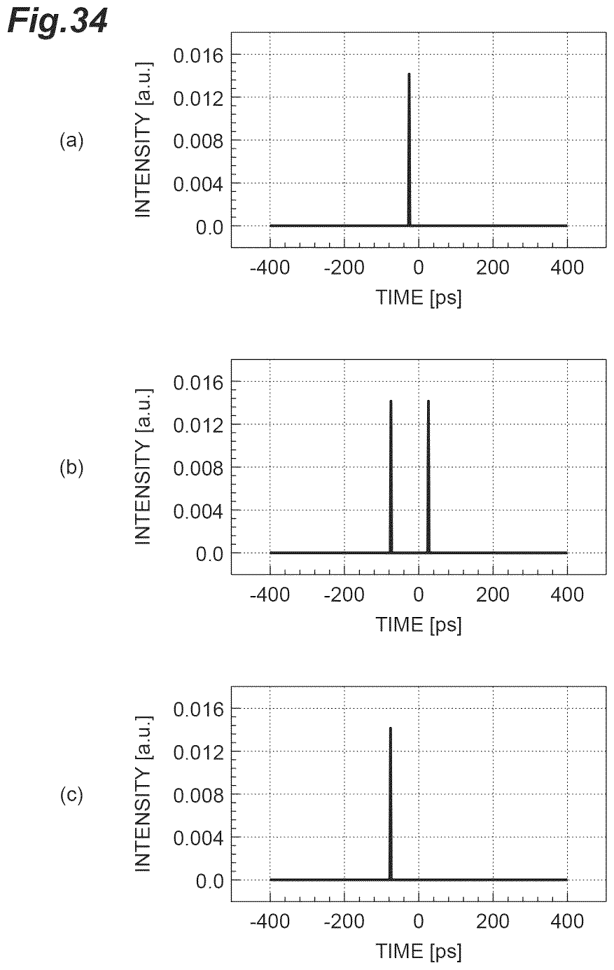

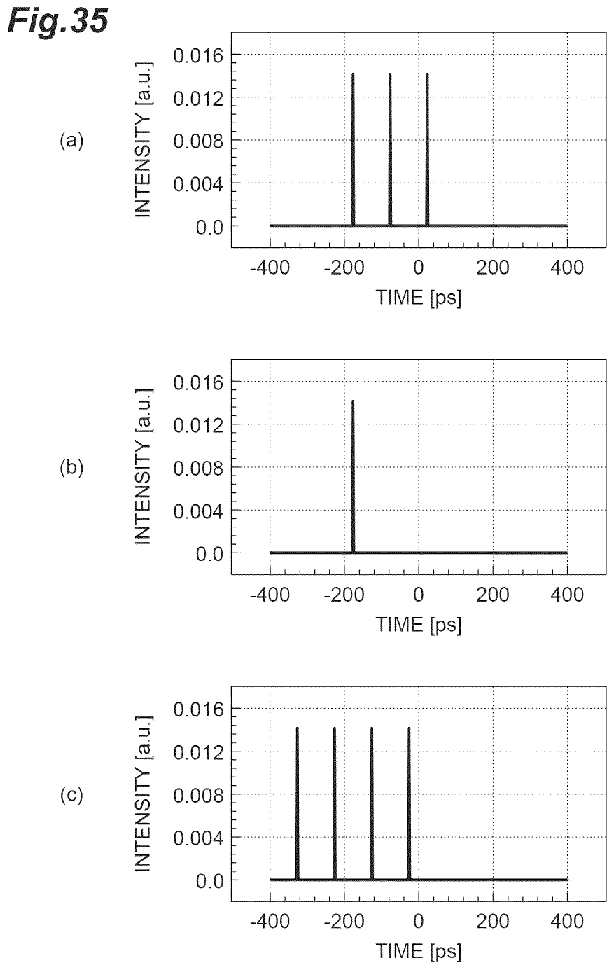

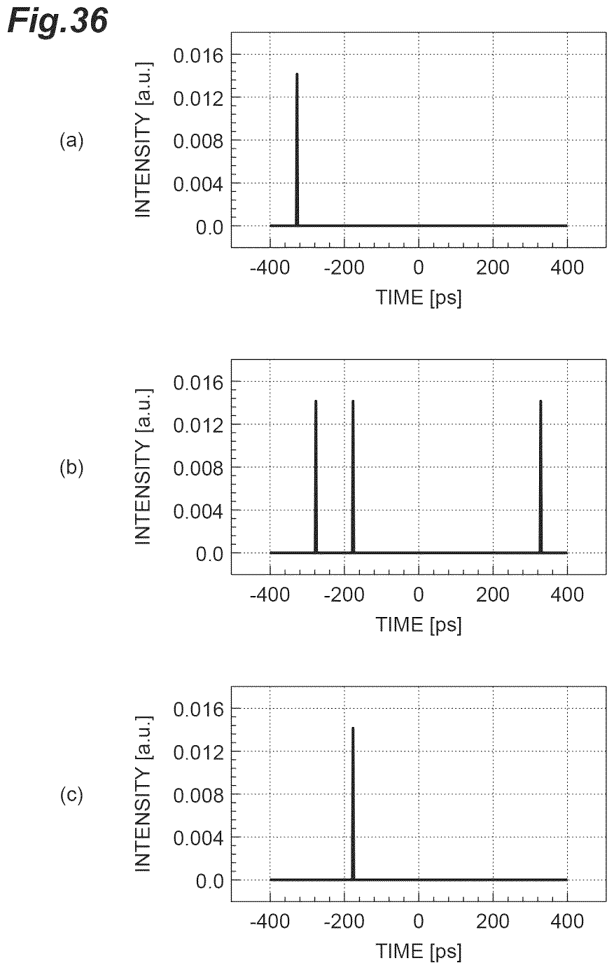

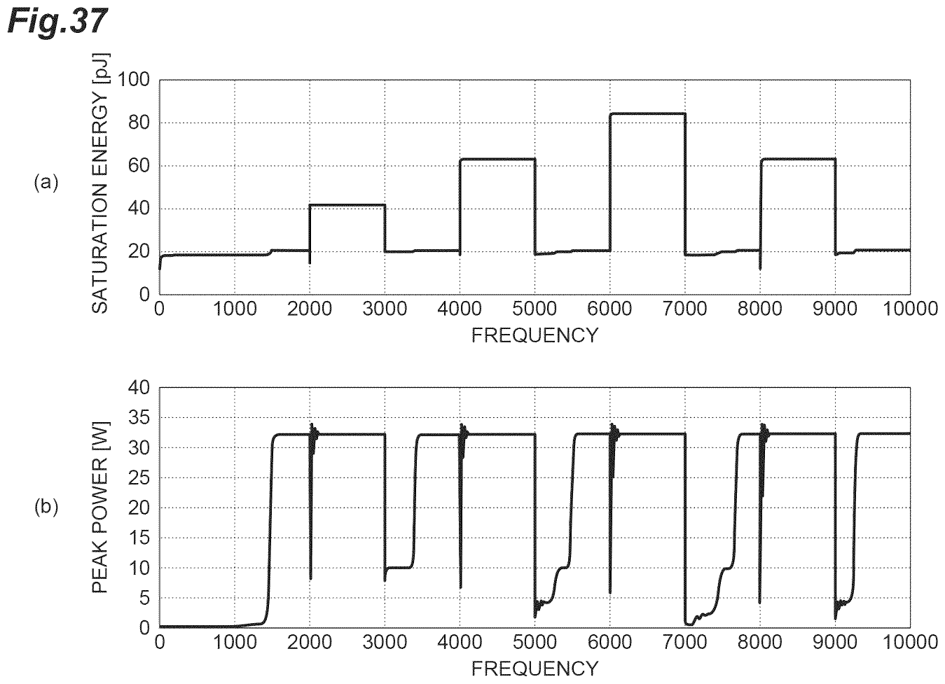

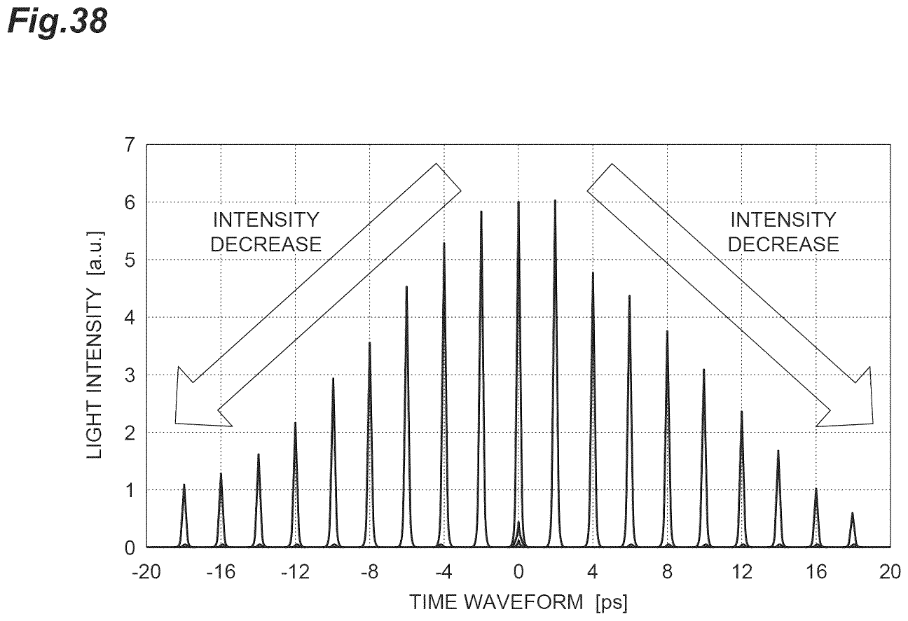

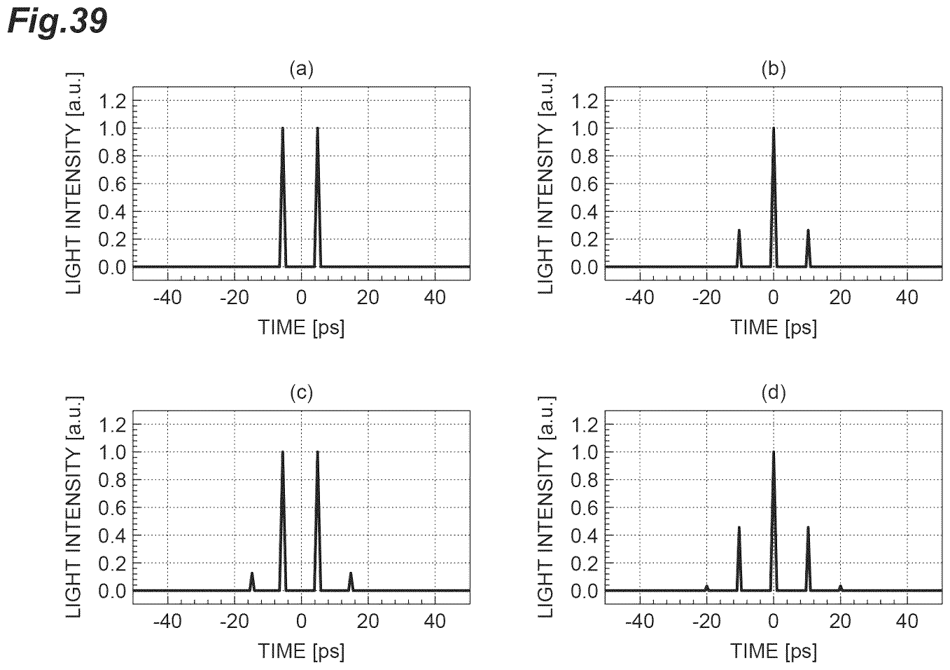

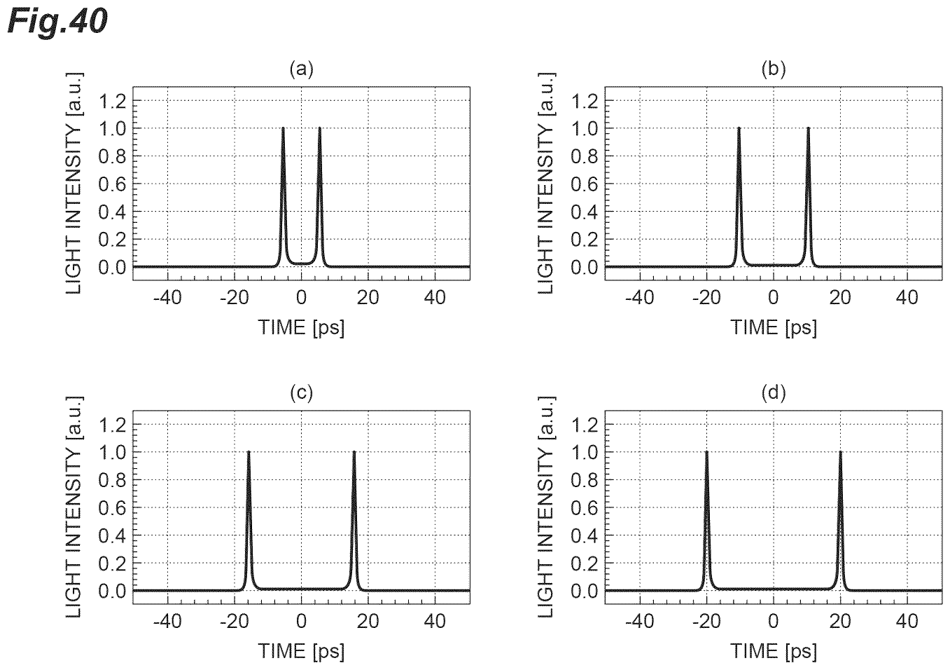

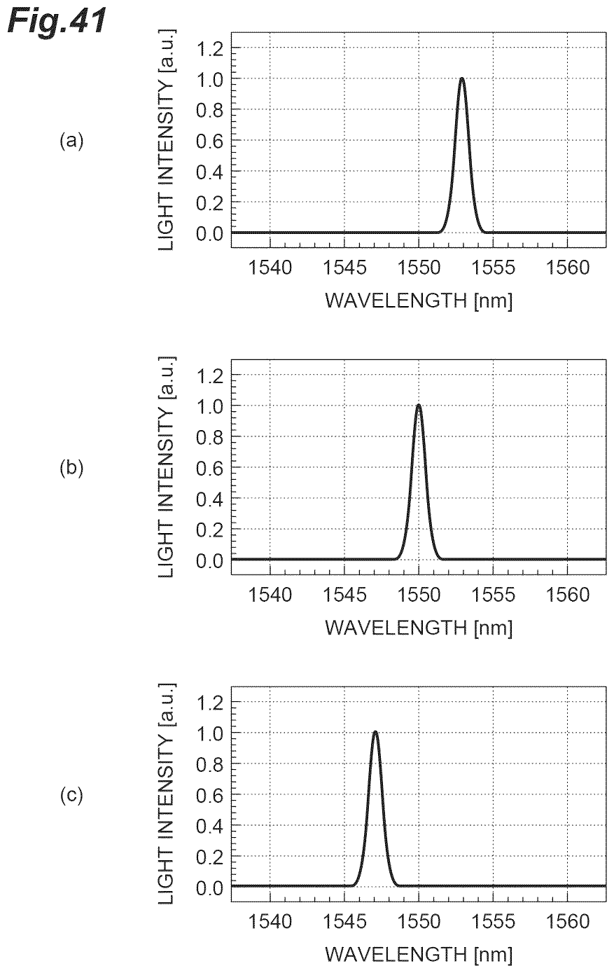

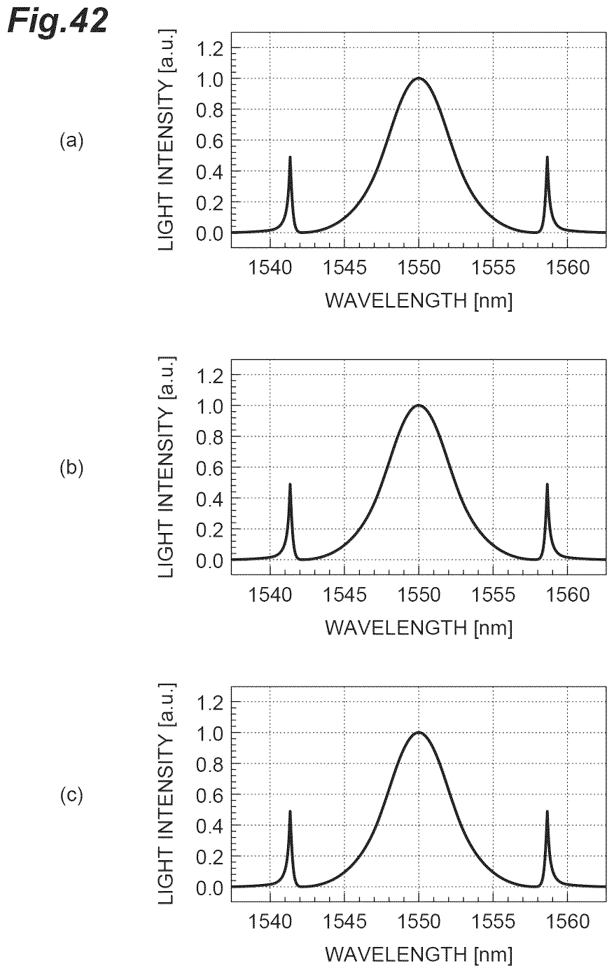

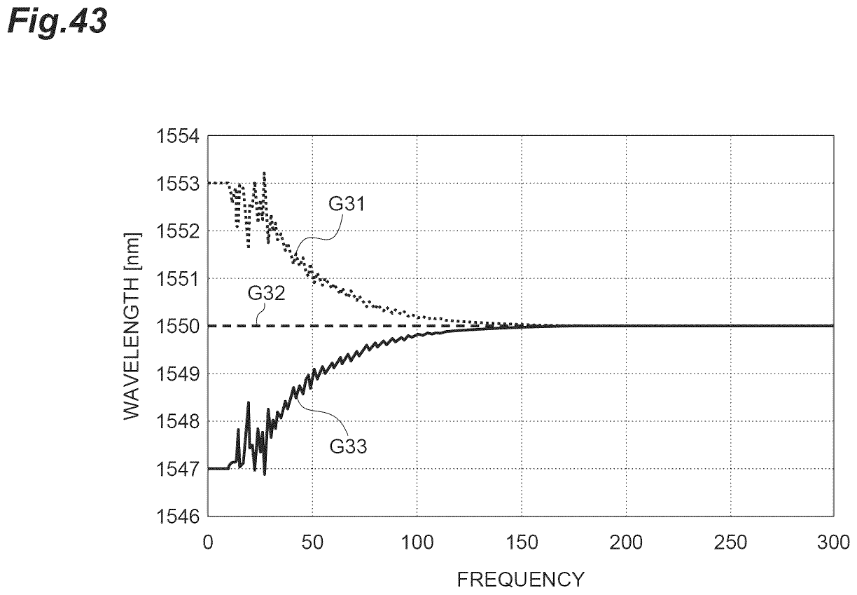

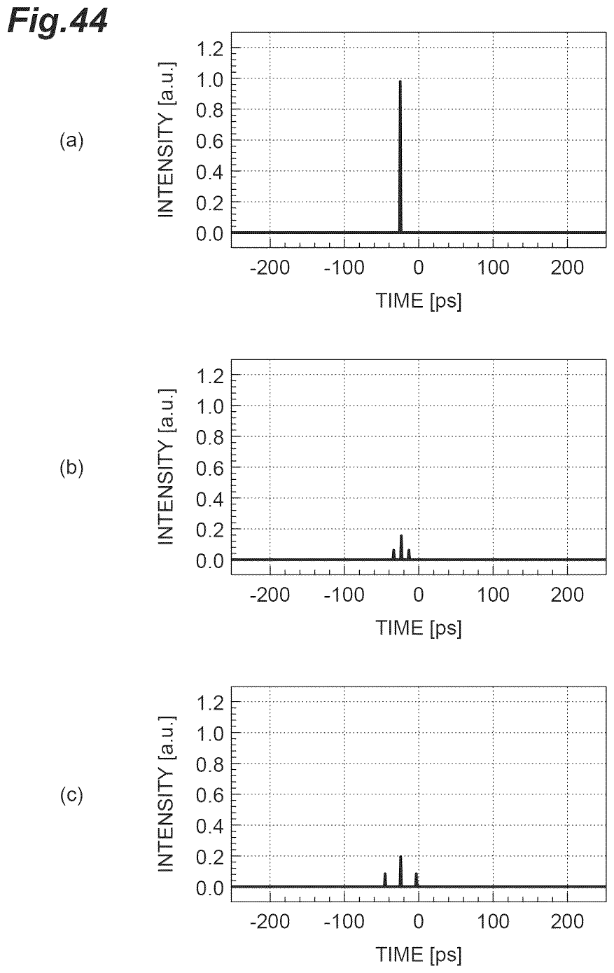

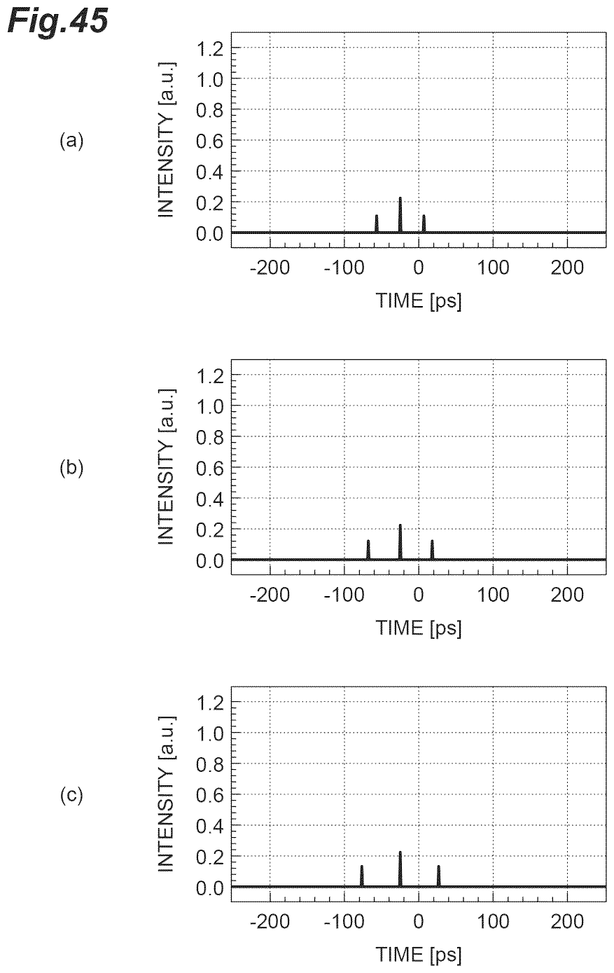

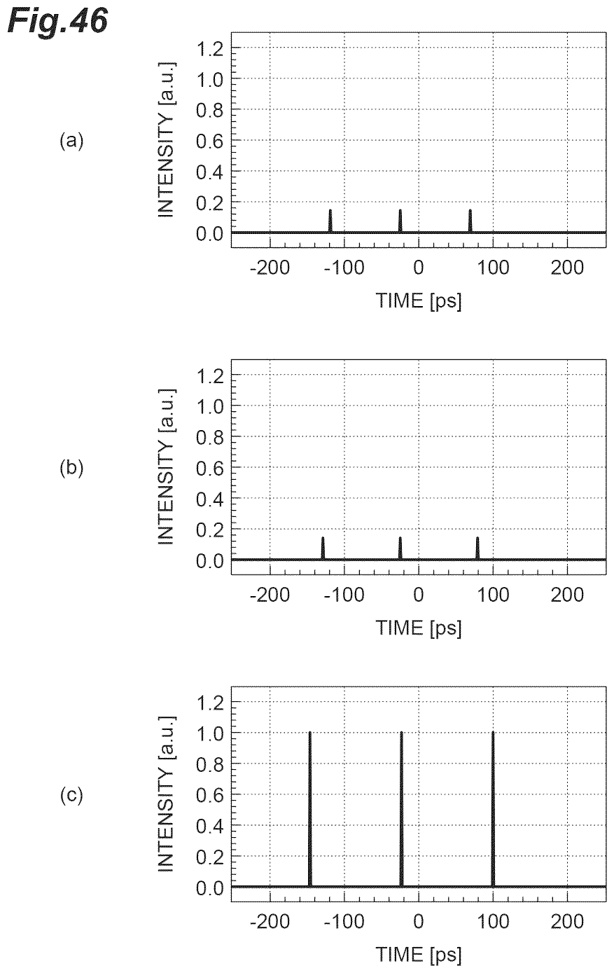

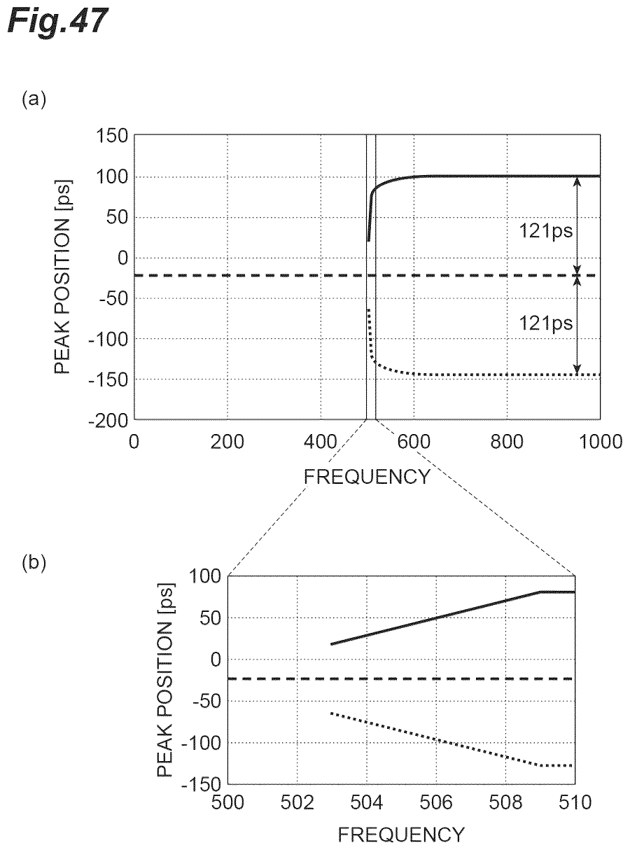

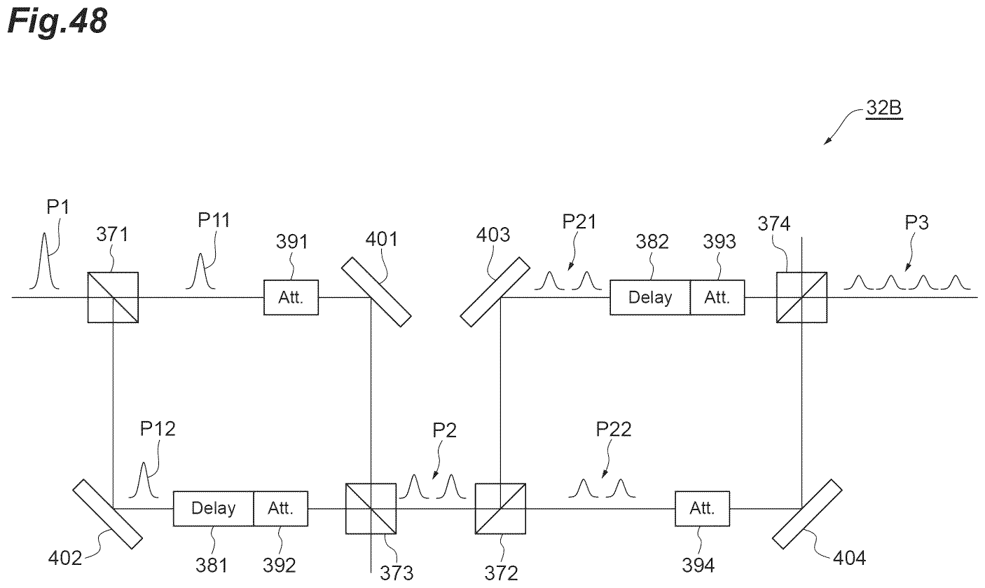

FIG. 4 is a diagram showing a modulation surface 326 of the SLM 323. As shown in FIG. 4, on the modulation surface 326, a plurality of modulation regions 327 are aligned along a predetermined direction AA, and each modulation region 327 extends in a direction AB crossing the direction AA. The direction AA is a spectral direction by the diffraction grating 321. The modulation surface 326 functions as a Fourier transform surface, and each corresponding wavelength component after spectral diffraction is incident on each of the plurality of modulation regions 327. The SLM 323 modulates the phase spectrum and the intensity spectrum of each incident wavelength component independently from other wavelength components in each modulation region 327. Since the SLM 323 of the present embodiment is of the phase modulation type, the intensity spectral modulation is realized by the phase pattern (phase image) presented on the modulation surface 326.

Each wavelength component of modulated light Pd modulated by the SLM 323 is collected at one point on the diffraction grating 325 by the lens 324. The lens 324 at this time functions as a condensing optical system that condenses the modulated light Pd. The lens 324 may be a convex lens formed of a light transmissive member, or may be a concave mirror having a concave light reflecting surface. The diffraction grating 325 functions as a multiplexing optical system, and multiplexes the modulated wavelength components. That is, a plurality of wavelength components of the modulated light Pd are condensed and multiplexed by the lens 324 and the diffraction grating 325 to form the optical pulse train Pe including two or more ultrashort optical pulses. The number of two or more ultrashort optical pulses included in the optical pulse train Pe and the time interval therebetween are variable, and can be freely set by changing the control signal from the controller for waveform control 41 provided to the SLM 323.

FIG. 1 is referred to again. The optical pulse generation device 1A further includes a pump laser 42, a current controller 43, a function generator 44, a splitter 45, a photodetector 46, and a pulse generator 47.

The pump laser 42 is a light source that is optically coupled to the optical resonator 20 and applies the excitation light Pa to the optical amplification medium 21. As shown in FIG. 2, a coupler 25 is arranged in the first optical path 201 of the optical resonator 20. The pump laser 42 is optically coupled to the optical amplification medium 21 through the coupler 25. The pump laser 42 may be, for example, a laser device including a laser diode. Alternatively, the pump laser 42 may be a solid state laser or a fiber laser. The pump laser 42 and the coupler 25 are optically coupled to each other through an optical fiber, for example. The light intensity of the excitation light Pa is variable, and the light intensity of the excitation light Pa is set to be higher as the number of optical pulses forming the optical pulse train Pe becomes larger.

The current controller 43 is electrically connected to the pump laser 42, and supplies a drive current Jd to the pump laser 42 and controls the magnitude of the drive current Jd. The current controller 43 receives a control signal Sc1 from the function generator 44, which will be described later, and controls the magnitude of the drive current Jd based on the control signal Sc1. The current controller 43 may be, for example, an analog circuit including transistors.

The function generator 44 provides the control signal Sc to the current controller 43. In addition, the function generator 44 functions as a switch controller that controls the optical path switch 31. The function generator 44 is electrically connected to the control terminal of the optical path switch 31, and provides the control terminal of the optical path switch 31 with a control signal Sc2 for switching between the second optical path 202 and the third optical path 203. As described above, the function generator 44 controls the optical path switch 31 to select the third optical path 203 in a predetermined period and select the second optical path 202 in the other periods.

The splitter 45 is optically coupled to one output port of the splitter 23. The splitter 45 splits the laser light Pout output from one output port of the splitter 23 into laser light Pout1 and laser light Pout2. The laser light Pout1 is output to the outside of the optical pulse generation device 1A. The laser light Pout2 is input to the photodetector 46. The splitter 45 may be, for example, a fiber coupler or a beam splitter.

The photodetector 46 detects the laser light Pout output from the optical resonator 20 and generates an electrical detection signal Sd. In the present embodiment, the photodetector 46 generates the electrical detection signal Sd corresponding to the light intensity of the laser light Pout2 split from the laser light Pout by the splitter 45. The photodetector 46 may be configured to include, for example, a photodiode or a photomultiplier tube. The photodetector 46 is mainly used to detect the output timing of the laser light Pout, which is an ultrashort pulse laser.

The pulse generator 47 is electrically connected to the photodetector 46. The pulse generator 47 receives the detection signal Sd from the photodetector 46 and generates a synchronization signal Sy that is a pulse signal synchronized with the detection signal Sd. The pulse generator 47 provides the generated synchronization signal Sy to the function generator 44. Based on the synchronization signal Sy, the function generator 44 determines the switching timing of the optical path switch 31 (specifically, the timing for selecting the third optical path 203) and the timing for changing the magnitude of the drive current Jd.

Next, an optical pulse generation method according to the present embodiment will be described together with the operation of the optical pulse generation device 1A of the present embodiment having the above configuration. FIG. 5 is a flowchart showing an optical pulse generation method. FIGS. 6 to 9 are diagrams showing each stage in the operation of the optical pulse generation device 1A.

First, the function generator 44 sets the optical path switch 31 to an optical path that does not pass through the waveform control device 32, that is, the second optical path 202 (step ST11 in FIG. 5). The arrow B in each diagram indicates the selection direction of the optical path switch 31. Then, the function generator 44 sets the light intensity of the excitation light Pa output from the pump laser 42 through the current controller 43 to a light intensity at which the laser light oscillates as a single pulse in the optical resonator 20. Then, the pump laser 42 applies the excitation light Pa to the optical amplification medium 21 in the optical resonator 20 to start the excitation of the optical amplification medium 21. At the beginning of the excitation, as shown in (a) in FIG. 6, light Pn including much noise circulates in the optical resonator 20. As shown in (b) in FIG. 6, one optical pulse is amplified from the noise with the elapse of time, and the ultrashort pulsed laser light Pb that is a single optical pulse is generated and amplified in the optical resonator 20 (laser light generation step ST12 in FIG. 5). The ultrashort pulsed laser light Pb is output from the optical resonator 20 as the laser light Pout shown in FIGS. 1 and 2.

As shown in (a) in FIG. 7, the function generator 44 sets the optical path switch 31 to an optical path that passes through the waveform control device 32, that is, the third optical path 203 (step ST13 in FIG. 5). Therefore, the ultrashort pulsed laser light Pb circulating in the optical resonator 20 is guided to the waveform control device 32.

The waveform control device 32 controls the time waveform of the ultrashort pulsed laser light Pb to convert the ultrashort pulsed laser light Pb into the any optical pulse train Pe including two or more optical pulses in the period of the optical resonator 20, as shown in (b) in FIG. 7 (waveform control step ST14 in FIG. 5). As described above, the number of two or more optical pulses included in the optical pulse train Pe and the time interval therebetween are freely controlled by the controller for waveform control 41. The time interval between the two or more optical pulses is, for example, 10 femtoseconds or more and 10 nanoseconds or less. The full width at half maximum of each optical pulse included in the two or more optical pulses is, for example, 10 femtoseconds or more and 1 nanosecond or less. The intensity of each optical pulse needs only to be larger than the noise in the optical resonator 20. The center wavelengths of the two or more optical pulses immediately after being converted by the waveform control step ST14 may be the same or may be different from each other.

After the elapse of a predetermined period from the setting of the optical path switch 31 in the third optical path 203, the function generator 44 sets the optical path switch 31 again to an optical path that does not pass through the waveform control device 32, that is, the second optical path 202 ((a) in FIG. 8, step ST15 in FIG. 5). As a result, the optical pulse train Pe introduced into the optical resonator 20 is confined in the optical resonator including the first optical path 201 and the second optical path 202. As described above, the predetermined period is, for example, a time required for the optical pulse to circulate once in the optical resonator 20. In this case, the operation for conversion into the optical pulse train Pe is performed only once in a predetermined period. Alternatively, the predetermined period may be a time required for the optical pulse to circulate in the optical resonator 20 multiple times. In this case, the operation for conversion into the optical pulse train Pe is performed multiple times in a predetermined period.

The function generator 44 changes the light intensity of the excitation light Pa output from the pump laser 42 through the current controller 43 to the light intensity corresponding to the number of optical pulses forming the optical pulse train Pe ((b) in FIG. 8, step ST16 in FIG. 5). In (b) in FIG. 8, the number of arrow feather-shaped figures representing the excitation light Pa corresponds to the light intensity of the excitation light Pa. At this time, the light intensity of the excitation light Pa is increased as the number of optical pulses forming the optical pulse train Pe increases. Typically, when the number of optical pulses forming the optical pulse train Pe is N (N is an integer of 2 or more), the light intensity of the excitation light Pa is set to N times the light intensity of the excitation light Pa when generating the ultrashort pulsed laser light Pb that is a single optical pulse. The order of steps ST15 and ST16 may be reversed.

Thereafter, as shown in FIG. 9, the optical pulse train Pe is laser-amplified in the optical resonator 20 to become ultrashort pulsed laser light including two or more optical pulses, which is different from the ultrashort pulsed laser light Pb. This ultrashort pulsed laser light is output from the optical resonator 20 as the laser light Pout shown in FIGS. 1 and 2 (output step ST17 in FIG. 5).

The ultrashort pulsed laser light including two or more optical pulses is output from the optical resonator 20 for any time. Thereafter, it is determined whether or not to change the number of optical pulses forming the optical pulse train Pe or the time interval between the optical pulses forming the optical pulse train Pe or both (step ST18 in FIG. 5). If none of these are changed (step ST18; NO), the excitation light Pa is turned off to end the operation of the optical pulse generation device 1A. If one of these is to be changed (step ST18; YES), the function generator 44 changes (dims) the light intensity of the excitation light Pa output from the pump laser 42 through the current controller 43 to the light intensity corresponding to the single optical pulse (step ST19 in FIG. 5). As a result, the number of optical pulses laser-oscillating in the optical resonator 20 is reduced to one, and the one optical pulse is amplified as laser light in the optical resonator 20. Thereafter, steps ST13 to ST18 are repeated.

Effects obtained by the optical pulse generation method and the optical pulse generation device 1A of the present embodiment having the above configuration will be described. In a mode-locked optical resonator, when an optical amplification medium is excited, an ultrashort optical pulse that is laser light is periodically generated and output. Depending on the oscillation conditions such as the intensity of excitation light, two or more ultrashort optical pulses that are temporally close to each other are generated. However, in previous reports, the time interval between two or more ultrashort optical pulses was random, and it was not realized to control the time interval. Therefore, the inventors of the present invention studied a method for freely controlling the random time interval and the number of ultrashort optical pulses. As a result, the inventors of the present invention found that the time interval between ultrashort optical pulses and the number of ultrashort optical pulses could be freely changed by instantaneous waveform control in a mode-locked optical resonator.

In the optical pulse generation device 1A of the present embodiment, the waveform controller 30 is provided in the mode-locked optical resonator 20. The waveform controller 30 controls the time waveform of the ultrashort pulsed laser light Pb within a predetermined period to convert the ultrashort pulsed laser light Pb into an optical pulse train Pe including two or more optical pulses. Similarly, in the optical pulse generation method of the present embodiment, in the waveform control step ST14, the time waveform of the ultrashort pulsed laser light Pb in the optical resonator 20 is controlled within a predetermined period to convert the ultrashort pulsed laser light Pb into the optical pulse train Pe including two or more optical pulses within the period of the optical resonator 20. In these cases, if an appropriate amount of excitation light Pa continues to be applied to the optical amplification medium 21, the optical pulse train Pe is amplified in the optical resonator 20 and output as the laser light Pout. The number of optical pulses included in the laser light Pout matches the number of optical pulses in the original optical pulse train Pe. In addition, the time interval between the optical pulses included in the laser light Pout matches the time interval between the optical pulses in the original optical pulse train Pe, or matches the time interval theoretically calculated from the time interval between the optical pulses in the original optical pulse train Pe. Therefore, according to the optical pulse generation device 1A and the optical pulse generation method of the present embodiment, it is possible to stably output the laser light Pout, which is an optical pulse train including two or more temporally close ultrashort optical pulses, with a predetermined number of pulses and a predetermined time interval with good reproducibility.

As in the present embodiment, the number of two or more optical pulses and the time interval between the two or more optical pulses may be variable. Then, after the output step ST17, the waveform control step ST14 and the output step ST17 may be repeated by changing at least one of the number of two or more optical pulses and the time interval between the two or more optical pulses. As described above, in burst laser processing or the like, the number of pulses in a pulse train and the time interval between the pulses are important parameters. The ultrashort pulse train with a time interval between optical pulses of less than 1 nanosecond can also be generated by using, for example, an interferometer. However, in the method using an interferometer, it takes time to change the number of pulses in a pulse train and the time interval between the pulses, and frequent changes of these lead to a decrease in throughput. Therefore, the method using an interferometer is suitable for repeating the same processing on a predetermined object, but is practically unsuitable for repeating processing while optimizing the processing conditions according to various materials and shapes of objects. In the optical pulse generation device 1A and the optical pulse generation method of the present embodiment, the light intensity of the optical pulse train Pe before amplification needs only to be larger than the noise of the light Pn shown in (a) in FIG. 6. Therefore, making variable the number of pulses and the time interval between the pulses in the optical pulse train Pe generated in the waveform controller 30 can be easily realized by using the pulse shaper 32A shown in FIG. 3, for example. Therefore, according to the optical pulse generation device 1A and the optical pulse generation method of the present embodiment, it is possible to easily repeat processing while optimizing the processing conditions according to various materials and shapes of objects.

As in the present embodiment, when the number of two or more optical pulses is variable, the light intensity of the excitation light Pa is variable. Therefore, the light intensity of the excitation light Pa may be increased as the number of optical pulses forming the optical pulse train Pe increases. When repeating the waveform control step ST14 and the output step ST17 while changing the number of two or more optical pulses, in the output step S17 (more precisely, in the step ST16 before the output step S17), the light intensity of the excitation light Pa applied to the optical amplification medium 21 may be increased as the number of optical pulses forming the optical pulse train Pe increases. If the light intensity of the excitation light Pa is too small relative to the number of optical pulses, some optical pulses may disappear without being amplified sufficiently. If the light intensity of the excitation light Pa is too large relative to the number of optical pulses, a part of noise unrelated to the optical pulse train Pe may be amplified to cause an unintended increase in the number of optical pulses. By increasing the light intensity of the excitation light Pa as the number of optical pulses forming the optical pulse train Pe increases, the excitation light Pa having an appropriate light intensity according to the number of optical pulses can be applied to the optical amplification medium 21.

As in the present embodiment, before repeating the waveform control step ST14 after the output step ST17, the light intensity of the excitation light Pa applied to the optical amplification medium 21 may be changed from the magnitude corresponding to the number of optical pulses forming the optical pulse train Pe to the magnitude corresponding to one optical pulse. As a result, the number of optical pulses is reduced to one, and the one optical pulse is amplified as the ultrashort pulsed laser light Pb in the optical resonator 20. In this manner, by always reducing the number of optical pulses to only one before generating two or more optical pulses in the waveform control step ST14, any number of optical pulses can be stably generated in the subsequent waveform control step ST14. Therefore, the number of optical pulses can be stably changed. According to simulations to be described later, when the light intensity of the excitation light Pa is reduced from the light intensity corresponding to two or more optical pulses to the light intensity corresponding to a single optical pulse, one of the two or more optical pulses is left and the other optical pulses disappear.

As in the present embodiment, the waveform controller 30 may have the optical path switch 31 and the waveform control device 32 that controls the time waveform of the ultrashort pulsed laser light Pb to convert the ultrashort pulsed laser light Pb into the optical pulse train Pe. The optical resonator 20 may include the first optical path 201, the second optical path 202, and the third optical path 203. As described above, the first optical path 201 has one end optically coupled to one input port of the optical path switch 31. The second optical path 202 has one end optically coupled to one output port of the optical path switch 31 and the other end optically coupled to the other end of the first optical path 201. The third optical path 203 has one end optically coupled to another output port of the optical path switch 31 and the other end optically coupled to the other end of the first optical path 201. The optical amplification medium 21 and the saturable absorber 24 may be arranged on the first optical path 201. The waveform control device 32 may be arranged on the third optical path 203. The optical path switch 31 may select the third optical path 203 in a predetermined period and select the second optical path 202 in the other periods. In this case, it can be easily realized that the waveform controller 30 controls the time waveform of the laser light in the optical resonator 20 only within a predetermined period.

As in the present embodiment, the optical pulse generation device 1A may include the photodetector 46 and the function generator 44. As described above, the photodetector 46 is optically coupled to the optical resonator 20, and detects laser light Lout output from the optical resonator 20 and generates the electrical detection signal Sd. The function generator 44 is a switch controller that controls the optical path switch 31. The function generator 44 may determine the timing for selecting the third optical path 203 based on the detection signal Sd from the photodetector 46. In this case, the switching timing of the optical path in the optical path switch 31 can be stably controlled.

As in the present embodiment, the optical resonator 20 may generate a single-pulse ultrashort pulsed laser light Pb before a predetermined period. The waveform controller 30 may have the diffraction grating 321, the SLM 323, the lens 324, and the diffraction grating 325. As described above, the diffraction grating 321 is a spectral element for spectral diffraction of the ultrashort pulsed laser light Pb. The SLM 323 performs modulation for converting the ultrashort pulsed laser light Pb into an optical pulse train Pe for the intensity spectrum or the phase spectrum or both of the light Pc after spectral diffraction, and outputs the modulated light Pd. The lens 324 and the diffraction grating 325 are a multiplexing optical system that collects the modulated light Pd and outputs the optical pulse train Pe. For example, such a waveform controller 30 can stably generate the optical pulse train Pe, which includes two or more temporally close ultrashort optical pulses, with a predetermined number of pulses and a predetermined time interval.

As described above, the center wavelengths of two or more optical pulses immediately after being converted by the waveform controller 30 (or immediately after being converted by the waveform control step ST14) may be the same with each other or may be different from each other. When the center wavelengths of two or more optical pulses are the same with each other, the time interval between the optical pulses at the beginning of conversion can be maintained without being affected by chromatic dispersion in the optical resonator 20. When the center wavelengths of two or more optical pulses are different from each other, the time interval between the optical pulses gradually increases after conversion due to the influence of chromatic dispersion in the optical resonator 20. Then, according to simulations to be described later, the center wavelength of each optical pulse gradually converges to one wavelength with the elapse of time, so that the time interval between the optical pulses does not increase beyond a certain magnitude. In addition, the magnitude of the time interval between two or more optical pulses can be calculated in advance by using parameters such as chromatic dispersion. Therefore, it is possible to output the laser light Lout having a pulse interval larger than the pulse interval that can be realized in the waveform controller 30 or the waveform control step ST14.

As in the present embodiment, the time waveform of the laser light circulating in the optical resonator 20 may be controlled only once within a predetermined period, or may be controlled multiple times within a predetermined period. In particular, when the center wavelengths of two or more optical pulses immediately after conversion are different from each other, the time waveform of the laser light is controlled multiple times within a predetermined period, so that the time interval between the optical pulses increases during the period. Therefore, it is possible to output laser light with a wider pulse interval.

Here, a modulation method for converting the single-pulse ultrashort pulsed laser light Pb into the optical pulse train Pe in the SLM 323 of the pulse shaper 32A shown in FIG. 3 will be described in detail. A region in front of the lens 324 (spectral domain) and a region behind the diffraction grating 325 (time domain) have a Fourier transform relationship therebetween. Phase modulation in the spectral domain affects the time intensity waveform in the time domain. Therefore, the output light from the pulse shaper 32A can have various time intensity waveforms, which are different from those of the ultrashort pulsed laser light Pb, according to the phase pattern of the SLM 323.
(a) in FIG. 10 shows, as an example, a spectral waveform (spectral phase G11 and spectral intensity G12) of the single-pulse ultrashort pulsed laser light Pb. (b) in FIG. 10 shows a time intensity waveform of the ultrashort pulsed laser light Pb. (a) in FIG. 11 shows, as an example, a spectral waveform (spectral phase G21 and spectral intensity G22) of output light from the pulse shaper 32A when the SLM 323 performs rectangular-wave phase spectrum modulation. (b) in FIG. 11 shows a time intensity waveform of the output light. In (a) in FIGS. 10 and 11, the horizontal axis indicates a wavelength (nm), the left vertical axis indicates the intensity value (any unit) of the intensity spectrum, and the right vertical axis indicates the phase values (rad) of the phase spectrum. In (b) in FIGS. 10 and 11, the horizontal axis indicates time (femtoseconds) and the vertical axis indicates light intensity (any unit).

In this example, a single pulse of the ultrashort pulsed laser light Pb is converted into a double pulse with higher order light by applying a rectangular phase spectrum waveform to the output light. The spectrum and waveform shown in FIG. 11 are one example. By combining various phase spectra and intensity spectra, the time intensity waveform of the output light from the pulse shaper 32A can be shaped into various shapes.

The phase pattern for approximating the time intensity waveform of the output light of the pulse shaper 32A to the desired waveform is configured as data for controlling the SLM 323, that is, data including a table of intensity of complex amplitude distribution or intensity of phase distribution. The phase pattern is, for example, computer-generated holograms (CGH). In the present embodiment, phase patterns including a phase pattern for phase modulation, which is for applying a phase spectrum for obtaining a desired waveform to the output light, and a phase pattern for intensity modulation, which is for giving an intensity spectrum for obtaining a desired waveform to the output light, are presented by the SLM 323.

Here, the desired time intensity waveform is expressed as a function of the time domain, and the phase spectrum is expressed as a function of the frequency domain. Therefore, a phase spectrum corresponding to the desired time intensity waveform is obtained, for example, by an iterative Fourier transform based on the desired time intensity waveform. FIG. 12 is a diagram showing the procedure for calculating the phase spectrum by the iterative Fourier transform method.

First, an initial intensity spectrum function A₀(ω) and a phase spectrum function Ψ₀(ω), which are functions of a frequency ω, are prepared (process number (1) in the diagram). In one example, the intensity spectrum function A₀(ω) and the phase spectrum function Ψ₀(ω) indicate the spectral intensity and spectral phase of the input light, respectively. Then, a waveform function (a) in the frequency domain including the intensity spectrum function A₀(ω) and the phase spectrum function Ψₙ(ω) is prepared (process number (2) in the diagram).

[Expression 1]

\sqrt{A₀(ω)}exp{iΨₙ(ω)} (a)

The subscript n indicates after the n-th Fourier transform process. Before the first Fourier transform process, the above-described initial phase spectrum function Ψ₀(ω) is used as the phase spectrum function Ψₙ(ω). i is an imaginary number.

Subsequently, the function (a) is subjected to Fourier transform from the frequency domain to the time domain (arrow A1 in the diagram). As a result, a waveform function (b) in the frequency domain including a time intensity waveform function bₙ(t) and a time phase waveform function Θₙ(t) is obtained (process number (3) in the diagram).

[Expression 2]

\sqrt{bₙ(t)}exp{iΘₙ(t)} (b)

Subsequently, the time intensity waveform function bₙ(t) included in the function (b) is replaced with a time intensity waveform function Target₀(t) based on a desired waveform (for example, the time interval and the number of optical pulses) (process numbers (4) and (5) in the diagram).

[Expression 3]

bₙ(t):=Target₀(t) (c)

[Expression 4]

\sqrt{Target₀(t)}exp{iΘₙ(t)} (d)

Subsequently, the function (d) is subjected to inverse Fourier transform from the time domain to the frequency domain (arrow A2 in the diagram). As a result, a waveform function (e) in the frequency domain including an intensity spectrum function Bₙ(ω) and a phase spectrum function Ψₙ(ω) is obtained (process number (6) in the diagram).

[Expression 5]

\sqrt{Bₙ(ω)}exp{iΨₙ(ω)} (e)

Subsequently, in order to constrain the intensity spectrum function Bₙ(ω) included in the function (e), the intensity spectrum function Bₙ(ω) is replaced with the initial intensity spectrum function A₀(ω) (process number (7) in the diagram).

[Expression 6]

Bₙ(ω)=A₀(ω) (f)

Thereafter, by repeating the process numbers (2) to (7) multiple times, the phase spectrum shape represented by the phase spectrum function Ψₙ(ω) in the waveform function can be approximated to the phase spectrum shape corresponding to the desired time intensity waveform. Based on a finally obtained phase spectrum function Ψ_{IFTA}(ω), a phase pattern for obtaining a desired time intensity waveform, that is, the optical pulse train Pe including two or more optical pulses is generated.

In the iterative Fourier method described above, it is possible to control the time intensity waveform, but it is not possible to control the frequency components (band wavelengths) forming the time intensity waveform. Therefore, when the center wavelengths of two or more optical pulses forming the optical pulse train Pe are set to be different from each other, the phase spectrum function and the intensity spectrum function on which the phase pattern is based are calculated by using a calculation method to be described below. FIG. 13 is a diagram showing the procedure for calculating the phase spectrum function.

First, an initial intensity spectrum function A₀(ω) and a phase spectrum function Φ₀(ω), which are functions of the frequency o, are prepared (process number (1) in the diagram). In one example, the intensity spectrum function A₀(ω) and the phase spectrum function Φ₀(ω) indicate the spectral intensity and spectral phase of the input light, respectively. Then, a first waveform function (g) in the frequency domain including the intensity spectrum function A₀(ω) and the phase spectrum function Φ₀(ω) is prepared (process number (2-a)). Here, i is an imaginary number.

[Expression 7]

\sqrt{A₀(ω)}exp{iΦ₀(ω)} (g)

Subsequently, the function (g) is subjected to Fourier transform from the frequency domain to the time domain (arrow A3 in the diagram). As a result, a second waveform function (h) in the time domain including a time intensity waveform function a₀(t) and a time phase waveform function φ₀(t) is obtained (process number (3)).

[Expression 8]

\sqrt{a₀(t)}exp{iφ₀(t)} (h)

Subsequently, as shown in the following Expression (i), the time intensity waveform function Target₀(t) based on the desired waveform (for example, the time interval and the number of optical pulses) is substituted into the time intensity waveform function b₀(t) (process number (4-a)).

[Expression 9]

b₀(t)=Target₀(t) (i)

Subsequently, as shown in the following Expression (j), the time intensity waveform function a₀(t) is replaced with the time intensity waveform function b₀(t). That is, the time intensity waveform function a₀(t) included in the function (h) is replaced with the time intensity waveform function Target₀(t) based on the desired waveform (for example, the time interval and the number of optical pulses) (process number (5)).

[Expression 10]

\sqrt{b₀(t)}exp{iφ₀(t)} (j)

Subsequently, the second waveform function (j) is modified so that the spectrogram of the second waveform function (j) after replacement approaches a target spectrogram generated in advance according to the desired wavelength band. First, by subjecting the second waveform function (j) after replacement to time-frequency conversion, the second waveform function (j) is converted into a spectrogram SG_{0,k}(ω, t) (process number (5-a) in the diagram). The subscript k indicates the k-th conversion process.

Here, the time-frequency conversion refers to performing frequency filter processing or numerical calculation processing on a composite signal, such as a time waveform, and converting the composite signal into three-dimensional information including time, frequency, and signal component intensity (spectral intensity). The numerical calculation processing is, for example, processing for deriving the spectrum for each time by performing multiplication while shifting the window function. In the present embodiment, the conversion result (time, frequency, and spectral intensity) is defined as a “spectrogram”. Examples of the time-frequency conversion include, for example, short-time Fourier transform (STFT) and wavelet transform (Haar wavelet transform, Gabor wavelet transform, Mexican Hat wavelet transform, Morlet wavelet transform).

In addition, a target spectrogram TargetSG₀(ω, t) generated in advance according to the desired wavelength band is acquired. The target spectrogram TargetSG₀(ω, t) has approximately the same value as the target time waveform (time intensity waveform and frequency components forming the time intensity waveform), and is generated in the target spectrogram function of process number (5-b).

Then, pattern matching is performed between the spectrogram SG_{0,k}(ω, t) and the target spectrogram TargetSG₀(ω, t) to check the degree of similarity (how much these match each other). In the present embodiment, an evaluation value is calculated as an index indicating the degree of similarity. Then, in the subsequent process number (5-c), it is determined whether or not the obtained evaluation value satisfies predetermined end conditions. If the conditions are satisfied, the process proceeds to the process number (6), and if the conditions are not satisfied, the process proceeds to the process number (5-d). In the process number (5-d), the time phase waveform function φ₀(t) included in the second waveform function is changed to any time phase waveform function φ_{0,k}(t). The second waveform function after changing the time phase waveform function is converted again into a spectrogram by time-frequency conversion such as STFT.

Thereafter, the process numbers (5-a) to (5-d) described above are repeated. In this manner, the second waveform function is modified such that the spectrogram SG_{0,k}(ω, t) gradually approaches the target spectrogram TargetSG₀(ω, t). Thereafter, an inverse Fourier transform is performed on the modified second waveform function (arrow A4 in the diagram) to generate a third waveform function (k) in the frequency domain (process number (6)).

[Expression 11]

\sqrt{B_{0,k}(ω)}exp{iΦ_{0,k}(ω)} (k)

The phase spectrum function Φ_{0,k}(ω) included in the third waveform function (k) becomes a desired phase spectrum function Φ_{TWC-TFD}(ω) finally obtained. A phase pattern is generated based on the phase spectrum function Φ_{TWC-TFD}(ω).

FIG. 14 is a diagram showing a procedure for calculating the spectral intensity. Since process numbers (1) to (5-c) are the same as the procedure for calculating the spectral phase described above, description thereof will be omitted.

If the evaluation value indicating the degree of similarity between the spectrogram SG_{0,k}(ω, t) and the target spectrogram TargetSG₀(ω, t) does not satisfy predetermined end conditions, the time intensity waveform function b₀(t) is changed to any time intensity waveform function b_{0,k}(t) while constraining the time phase waveform function φ₀(t) included in the second waveform function to the initial value (process number (5-e)). The second waveform function after changing the time intensity waveform function is converted again into a spectrogram by time-frequency conversion such as STFT.

Thereafter, the process numbers (5-a) to (5-c) are repeated. In this manner, the second waveform function is modified such that the spectrogram SG_{0,k}(ω, t) gradually approaches the target spectrogram TargetSG₀(ω, t). Thereafter, an inverse Fourier transform is performed on the modified second waveform function (arrow A4 in the diagram) to generate a third waveform function (m) in the frequency domain (process number (6)).

[Expression 12]

\sqrt{B_{0,k}(ω)}exp{iΦ_{0,k}(ω)} (m)

Subsequently, in process number (7-b), filtering processing based on the intensity spectrum of the input light is performed on the intensity spectrum function B_{0,k}(ω) included in the third waveform function (m). Specifically, of the intensity spectrum obtained by multiplying the intensity spectrum function B_{0,k}(ω) by a coefficient α, a portion exceeding the cutoff intensity for each wavelength determined based on the intensity spectrum of the input light is cut. This is to prevent the intensity spectrum function αB_{0,k}(ω) from exceeding the spectral intensity of the input light in all wavelength regions.

In one example, the cutoff intensity for each wavelength is set to match the intensity spectrum (in the present embodiment, the initial intensity spectrum function A₀(ω)) of the input light. In this case, as expressed in the following Expression (n), at frequencies where the intensity spectrum function αB_{0,k}(ω) is larger than the intensity spectrum function A₀(ω), the value of the intensity spectrum function A₀(ω) is taken as the value of the intensity spectrum function A_{TWC-TFD}(ω). In addition, at frequencies where the intensity spectrum function αB_{0,k}(ω) is equal to or less than the intensity spectrum function A₀(ω), the value of the intensity spectrum function αB_{0,k}(ω) is taken as the value of the intensity spectrum function A_{TWC-TFD}(ω) (process number (7-b) in the diagram).

$$\begin{matrix}[ Expression 13 ] & \\ {A}_{TWC ‐ TFD} ( ω ) = \{ \begin{matrix}{A}_{0} ( ω ) & {A}_{0} ( ω ) < α {B}_{0 , k} ( ω ) \\ α {B}_{0 , k} ( ω ) & {A}_{0} ( ω ) \geq α {B}_{0 , k} ( ω )\end{matrix} & ( n )\end{matrix}$$

The intensity spectrum function A_{TWC-TFD}(ω) is used, as a desired spectral intensity finally obtained, to generate a phase pattern.

Then, a phase modulation pattern (for example, computer-generated holograms) for giving to the output light a spectral phase indicated by the phase spectrum function Φ_{TWC-TFD}(ω) and a spectral intensity indicated by the intensity spectrum function A_{TWC-TFD}(ω) is calculated. FIG. 15 is a diagram showing an example of a procedure for generating the target spectrogram TargetSG₀(ω, t). Since the target spectrogram TargetSG₀(ω, t) indicates a target time waveform (time intensity waveform and frequency components (wavelength band components) forming the time intensity waveform), generating the target spectrogram is an extremely important step for controlling frequency components (wavelength band components).

As shown in FIG. 15, first, a spectral waveform (initial intensity spectrum function A₀(ω) and initial phase spectrum function Φ₀(ω) and a desired time intensity waveform function Target₀(t) are input. In addition, a time function p₀(t) including desired frequency (wavelength) band information is input (process number (1)). Then, by using, for example, the iterative Fourier transform method shown in FIG. 12, a phase spectrum function Φ_{IFTA}(ω) for realizing the time intensity waveform function Target₀(t) is calculated (process number (2)). Then, by using the iterative Fourier transform method using the previously obtained phase spectrum function Φ_{IFTA}(ω), an intensity spectrum function A_{IFTA}(ω) for realizing the time intensity waveform function Target₀(t) is calculated (process number (3)). FIG. 16 is a diagram showing an example of the procedure for calculating the intensity spectrum function A_{IFTA}(ω).

First, an initial intensity spectrum function Aₖ₌₀(ω) and a phase spectrum function Ψ₀(ω) are prepared (process number (1) in the diagram). Then, a waveform function (o) in the frequency domain including an intensity spectrum function Aₖ(ω) and the phase spectrum function Ψ₀(ω) is prepared (process number (2) in the diagram).

[Expression 14]

\sqrt{Aₖ(ω)}exp{iΨ(ω)} (o)

The subscript k indicates after the k-th Fourier transform process. Before the first Fourier transform process, the above-described initial intensity spectrum function Aₖ₌₀(ω) is used as the intensity spectrum function Aₖ(ω). i is an imaginary number.

Subsequently, the function (o) is subjected to Fourier transform from the frequency domain to the time domain (arrow A5 in the diagram). As a result, a waveform function (p) in the frequency domain including a time intensity waveform function bₖ(t) is obtained (process number (3) in the diagram).

[Expression 15]

\sqrt{bₖ(t)}exp{iΘₖ(t)} (p)

Subsequently, the time intensity waveform function bₖ(t) included in the function (p) is replaced with the time intensity waveform function Target₀(t) based on a desired waveform (for example, the time interval and the number of optical pulses) (process numbers (4) and (5) in the diagram).

[Expression 16]

bₖ(t):=Target₀(t) (q)

[Expression 17]

\sqrt{Target₀(t)}exp{iΘₖ(t)} (r)

Subsequently, the function (r) is subjected to inverse Fourier transform from the time domain to the frequency domain (arrow A6 in the diagram). As a result, a waveform function (s) in the frequency domain including an intensity spectrum function Cₖ(ω) and a phase spectrum function Ψₖ(ω) is obtained (process number (6) in the diagram).

[Expression 18]

\sqrt{Cₖ(ω)}exp{iΨₖ(ω)} (s)

Subsequently, in order to constrain the phase spectrum function Ψₖ(ω) included in the function (s), the phase spectrum function Ψₖ(ω) is replaced with the initial phase spectrum function Ψ₀(ω) (process number (7-a) in the diagram).

[Expression 19]

Ψₖ(ω):=Ψ₀(ω) (t)

In addition, the intensity spectrum function Cₖ(ω) in the frequency domain after the inverse Fourier transform is subjected to filtering processing based on the intensity spectrum of the input light. Specifically, of the intensity spectrum expressed by the intensity spectrum function Cₖ(ω), a portion exceeding the cutoff intensity for each wavelength determined based on the intensity spectrum of the input light is cut.

In one example, the cutoff intensity for each wavelength is set to match the intensity spectrum (for example, the initial intensity spectrum function Aₖ₌₀(ω)) of the input light. In this case, as expressed in the following Expression (u), at frequencies where the intensity spectrum function Cₖ(ω) is larger than the intensity spectrum function Aₖ₌₀(ω), the value of the intensity spectrum function Aₖ₌₀(ω) is taken as the value of the intensity spectrum function Aₖ(ω). At frequencies where the intensity spectrum function Cₖ(ω) is equal to or less than the intensity spectrum function Aₖ₌₀(ω), the value of the intensity spectrum function Cₖ(ω) is taken as the value of the intensity spectrum function Aₖ(ω) (process number (7-b) in the diagram).

$$\begin{matrix}[ Expression 20 ] & \\ {A}_{k} ( ω ) = \{ \begin{matrix}{A}_{k = 0} ( ω ) , & {A}_{k = 0} ( ω ) < {C}_{k} ( ω ) \\ {C}_{k} ( ω ) , & {A}_{k = 0} ( ω ) \geq {C}_{k} ( ω )\end{matrix} & ( u )\end{matrix}$$

The intensity spectrum function Cₖ(ω) included in the function (s) is replaced with the intensity spectrum function Aₖ(ω) after the filtering processing according to Expression (u).

Thereafter, the above processes (2) to (7-b) are repeated. As a result, the intensity spectrum shape represented by the intensity spectrum function Aₖ(ω) in the waveform function can be approximated to the intensity spectrum shape corresponding to the desired time intensity waveform. Finally, the intensity spectrum function A_{IFTA}(ω) is obtained.

FIG. 15 is referred to again. By calculating the phase spectrum function Φ_{IFTA}(ω) and the intensity spectrum function A_{IFTA}(ω) in the process numbers (2) and (3) in FIG. 15 described above, a third waveform function (v) in the frequency domain including these functions is obtained (process number (4)).

[Expression 21]

\sqrt{A_{IFTA}(ω)}exp{iΦ_{IFTA}(ω)} (v)

Then, the waveform function (v) is Fourier transformed. As a result, a fourth waveform function (w) in the time domain is obtained (process number (5)).

[Expression 22]

\sqrt{a_{IFTA}(t)}exp{iφ_{IFTA}(t)} (w)

Then, the fourth waveform function (ω) is converted into a spectrogram SG_{IFTA}(ω, t) by time-frequency conversion (process number (6)). In the process number (7), by modifying the spectrogram SG_{IFTA}(ω, t) based on the time function p₀(t) including the desired frequency (wavelength) band information, the target spectrogram TargetSG₀(ω, t) is generated. For example, a characteristic pattern appearing in the spectrogram SG_{IFTA}(ω, t) configured by two-dimensional data is partially cut out, and the frequency component of the portion is manipulated based on the time function p₀(t). Hereinafter, a specific example thereof will be described in detail.

For example, a case is considered in which triple pulses having a time interval of 2 picoseconds are set as the desired time intensity waveform function Target₀(t). At this time, the resulting spectrogram SG_{IFTA}(ω, t) is shown in (a) in FIG. 17. In (a) in FIG. 17, the horizontal axis indicates time (unit: femtosecond), and the vertical axis indicates wavelength (unit: nm). In addition, the value of the spectrogram is indicated by the light and shade of the diagram. As the brightness increases, the value of the spectrogram increases. In this spectrogram SG_{IFTA}(ω, t), the triple pulses appear as domains D₁, D₂, and D₃ separated on the time axis at intervals of 2 picoseconds. The center (peak) wavelengths of the domains D₁, D₂, and D₃ are 800 nm.

If it is desired to control only the time intensity waveform of the output light (it is desired to simply obtain triple pulses), there is no need to manipulate these domains D₁, D₂, and D₃. However, if it is desired to control the frequency (wavelength) band of each pulse, it is necessary to manipulate these domains D₁, D₂, and D₃. That is, as shown in (b) in FIG. 17, moving the domains D₁, D₂, and D₃ independently of each other in a direction along the wavelength axis (vertical axis) means changing the component frequency (wavelength band) of each pulse. Such a change of the component frequency (wavelength band) of each pulse is performed based on the time function p₀(t).

For example, it is assumed that the time function p₀(t) is written such that the peak wavelength of the domain D₂ is fixed at 800 nm and the peak wavelengths of the domains D₁ and D₃ are translated by −2 nm and +2 nm, respectively. At this time, the spectrogram SG_{IFTA}(ω, t) changes to the target spectrogram TargetSG₀(ω, t) shown in (b) in FIG. 17. For example, by subjecting the spectrogram to such processing, it is possible to generate a target spectrogram in which the component frequency (wavelength band) of each pulse is arbitrarily controlled without changing the shape of the time intensity waveform.

### First Modification Example

FIG. 18 is a flowchart showing the operation of an optical pulse generation device 1A and an optical pulse generation method according to a first modification example. In the embodiment described above, the light intensity of the excitation light Pa is set to the light intensity at which the single-pulse ultrashort pulsed laser light Pb is generated, and the single-pulse ultrashort pulsed laser light Pb is converted into the optical pulse train Pe by the waveform control device 32. On the other hand, in this modification example, the light intensity of the excitation light Pa is set to the light intensity at which continuous-wave laser light (continuous light) is generated. The waveform control device 32 converts the laser light into the optical pulse train Pe by modulating the intensity of the continuous-wave laser light. In this case, the waveform control device 32 may be configured by an EOM (Electro Optic Modulator) or an integrated control chip.

The EOM is an intensity modulation element that uses the electro-optic effect. The EOM can modulate the light intensity at high speed, and can convert the laser light into an any optical pulse train Pe by modulating the intensity of the continuous-wave laser light. The integrated control chip is a miniaturized one obtained by integrating, for example, an EOM, a Mach-Zehnder interferometer, and a CMOS circuit on a single substrate.

As shown in FIG. 18, in this modification example, first, the optical path switch 31 is set in the second optical path 202 (step ST21). Then, the light intensity of the excitation light Pa output from the pump laser 42 is set to the light intensity at which the laser light continuously oscillates in the optical resonator 20. Then, the pump laser 42 applies the excitation light Pa to the optical amplification medium 21 in the optical resonator 20 to start the excitation of the optical amplification medium 21. As a result, continuous-wave laser light is generated and amplified in the optical resonator 20 (laser light generation step ST22). This laser light is output from the optical resonator 20 as the laser light Pout shown in FIGS. 1 and 2.

Then, the optical path switch 31 is set in the third optical path 203 (step ST23). As a result, the laser light laser-oscillating in the optical resonator 20 is guided to the waveform control device 32. The waveform control device 32 controls the time waveform of the laser light to convert the laser light into the optical pulse train Pe including two or more optical pulses within the period of the optical resonator 20 (waveform control step ST24). The center wavelengths of the two or more optical pulses immediately after being converted by the waveform control step ST24 are the same with each other.

After the elapse of a predetermined period from the setting of the optical path switch 31 in the third optical path 203, the optical path switch 31 is set again in the second optical path 202 (step ST25). As a result, the optical pulse train Pe introduced into the optical resonator 20 is confined in the optical resonator including the first optical path 201 and the second optical path 202. The length of the predetermined period is the same as in the embodiment described above.

Then, the light intensity of the excitation light Pa output from the pump laser 42 is changed to the light intensity corresponding to the number of optical pulses forming the optical pulse train Pe (step ST26). As in the embodiment described above, at this time, the light intensity of the excitation light Pa is increased as the number of optical pulses forming the optical pulse train Pe increases. Typically, when the number of optical pulses forming the optical pulse train Pe is N (N is an integer of 2 or more), the light intensity of the excitation light Pa is set to N times the light intensity of the excitation light Pa when generating the ultrashort pulsed laser light Pb that is a single optical pulse. The order of steps ST25 and ST26 may be reversed.

Thereafter, the optical pulse train Pe is laser-amplified in the optical resonator 20 to become ultrashort pulsed laser light including two or more optical pulses. The ultrashort pulsed laser light is output from the optical resonator 20 as the laser light Pout shown in FIGS. 1 and 2 (output step ST27).

The ultrashort pulsed laser light including two or more optical pulses is output from the optical resonator 20 for any time. Thereafter, it is determined whether or not to change the number of optical pulses forming the optical pulse train Pe or the time interval between the optical pulses forming the optical pulse train Pe or both (step ST28). If none of these are changed (step ST28; NO), the excitation light Pa is turned off to end the operation of the optical pulse generation device 1A. If any one of these is to be changed (step ST28; YES), the light intensity of the excitation light Pa output from the pump laser 42 is changed to the light intensity corresponding to (step ST29). As a result, continuous-wave laser light is generated and amplified again in the optical resonator 20. Thereafter, steps ST23 to ST28 are repeated.

As in this modification example, the optical resonator 20 may generate continuous-wave laser light before a predetermined period. Then, the waveform controller 30 may convert the laser light into the optical pulse train Pe by modulating the intensity of the laser light. For example, such a waveform controller 30 can also stably generate the optical pulse train Pe, which includes two or more temporally close ultrashort optical pulses, with a predetermined number of pulses and a predetermined time interval.

In the example described above, a configuration is adopted in which the second optical path 202 and the third optical path 203 are selected by the optical path switch 31. When the continuous-wave laser light is converted into the optical pulse train Pe as in this modification example, the waveform control device 32 capable of performing high-speed modulation may be used. In such a configuration, the optical path switch 31 and the second optical path 202 may not be provided. If the optical path switch 31 and the second optical path 202 are not provided, the laser light will always pass through the waveform control device 32. However, if it is possible to control the ON/OFF of the modulation at high speed, it is possible to perform the conversion operation only once or several times within a predetermined period that is an extremely short time.

### Second Modification Example

FIG. 19 is a block diagram showing the configuration of an optical pulse generation device 1B according to a second modification example. The optical pulse generation device 1B of the modification example includes a waveform controller 34 instead of the waveform controller 30 in the embodiment described above. The waveform controller 34 has a polarization switch 35 and a change-dependent waveform control device 36. In this modification example, the optical resonator 20 does not have the second optical path 202, and the waveform controller 34 does not have the optical path switch 31 and the coupler 33. That is, the optical path of the optical resonator 20 is configured only by the first optical path 201 and the third optical path 203. The polarization switch 35 and the waveform control device 36 are arranged on the third optical path 203 in the optical resonator 20.

The polarization switch 35 controls the polarization plane of the ultrashort pulsed laser light Pb circulating in the optical resonator 20. The polarization switch 35 sets the polarization plane of the ultrashort pulsed laser light Pb to a first polarization plane (for example, one of the p-polarization plane and the s-polarization plane) in a predetermined period during which waveform control is performed, and sets the polarization plane of the ultrashort pulsed laser light Pb to a second polarization plane (for example, the other one of the p-polarization plane and the s-polarization plane) different from the first polarization plane in the other periods. The polarization switch 35 is controlled by the function generator 44 (switch controller) at the same timing as the optical path switch 31 in the embodiment described above. Based on the detection signal Sd from the photodetector 46, the function generator 44 determines the timing for setting the polarization plane of the ultrashort pulsed laser light Pb to the first polarization plane. Therefore, the polarization switching timing in the polarization switch 35 can be stably controlled. The polarization switch 35 may be configured by an EOM, for example.

When the ultrashort pulsed laser light Pb has the first polarization plane, the waveform control device 36 controls the time waveform of the ultrashort pulsed laser light Pb to convert the ultrashort pulsed laser light Pb into the optical pulse train Pe. When the ultrashort pulsed laser light Pb has the second polarization plane, the waveform control device 36 does not control the time waveform of the ultrashort pulsed laser light Pb. Such a waveform control device 36 can be easily realized by making the SLM 323 be a polarization dependent type, for example, a liquid crystal type LCOS (Liquid Crystal on Silicon)-SLM in the pulse shaper 32A shown in FIG. 3, for example. That is, when the ultrashort pulsed laser light Pb has the first polarization plane, the SLM 323 phase-modulates the light Pc after spectral diffraction. When the ultrashort pulsed laser light Pb has the second polarization plane, the SLM 323 simply transmits the light Pc after spectral diffraction without performing phase modulation.

FIG. 20 is a flowchart showing the operation of the optical pulse generation device 1B and an optical pulse generation method of this modification example. First, the function generator 44 sets the polarization switch 35 to a polarization plane that is not waveform-controlled by the waveform control device 36, that is, the second polarization plane (step ST31). Then, the light intensity of the excitation light Pa output from the pump laser 42 is set to the light intensity at which the laser light oscillates as a single pulse in the optical resonator 20. Then, the pump laser 42 applies the excitation light Pa to the optical amplification medium 21 in the optical resonator 20 to start the excitation of the optical amplification medium 21. As a result, the ultrashort pulsed laser light Pb that is a single optical pulse is generated and amplified in the optical resonator 20 (laser light generation step ST32). The ultrashort pulsed laser light Pb is output from the optical resonator 20 as the laser light Pout shown in FIG. 19.

Then, the function generator 44 sets the polarization switch 35 to a polarization plane that is waveform-controlled by the waveform control device 36, that is, the first polarization plane (step ST33). This enables the waveform control device 36 to control the waveform of the ultrashort pulsed laser light Pb.

The waveform control device 36 controls the time waveform of the ultrashort pulsed laser light Pb to convert the ultrashort pulsed laser light Pb into the optical pulse train Pe (waveform control step ST34). The number of two or more optical pulses included in the optical pulse train Pe and the time interval therebetween are freely controlled by the controller for waveform control 41. The center wavelengths of the two or more optical pulses immediately after being converted by the waveform control step ST34 may be the same or may be different from each other.

After the elapse of a predetermined period from the setting of the polarization switch 35 to the first polarization plane, the function generator 44 sets the polarization switch 35 again to the polarization plane that is not waveform-controlled by the waveform control device 36, that is, the second polarization plane (step ST35). This enables the optical pulse train Pe to simply pass through the waveform control device 36. The length of the predetermined period is the same as in the embodiment described above.

Then, the light intensity of the excitation light Pa output from the pump laser 42 is changed to the light intensity corresponding to the number of optical pulses forming the optical pulse train Pe (step ST36). As in the embodiment described above, at this time, the light intensity of the excitation light Pa is increased as the number of optical pulses forming the optical pulse train Pe increases. Typically, when the number of optical pulses forming the optical pulse train Pe is N (N is an integer of 2 or more), the light intensity of the excitation light Pa is set to N times the light intensity of the excitation light Pa when generating the ultrashort pulsed laser light Pb that is a single optical pulse. The order of steps ST35 and ST36 may be reversed.

Thereafter, the optical pulse train Pe is laser-amplified in the optical resonator 20 to become ultrashort pulsed laser light including two or more optical pulses, which is different from the ultrashort pulsed laser light Pb. The ultrashort pulsed laser light is output from the optical resonator 20 as the laser light Pout shown in FIG. 19 (output step ST37).

After the ultrashort pulsed laser light including two or more optical pulses is output from the optical resonator 20 for an any time, it is determined whether or not to change the number of optical pulses forming the optical pulse train Pe or the time interval between the optical pulses forming the optical pulse train Pe or both (step ST38). If none of these are changed (step ST38; NO), the excitation light Pa is turned off to end the operation of the optical pulse generation device 1B. If one of these is to be changed (step ST38; YES), the light intensity of the excitation light Pa output from the pump laser 42 is changed (dimmed) to the light intensity corresponding to the single optical pulse (step ST39). As a result, the number of optical pulses laser-oscillating in the optical resonator 20 is reduced to one, and the one optical pulse is amplified as laser light in the optical resonator 20. Thereafter, steps ST33 to ST38 are repeated.

Even with the configuration of this modification example, the same effects as those of the above-described embodiment can be obtained. In addition, it is possible to easily realize a configuration in which the waveform controller 34 controls the time waveform of the ultrashort pulsed laser light Pb only within a predetermined period. This modification example may be combined with the configuration of the first modification example.

### EXAMPLES

In order to verify the effects of the above-described embodiment and each modification example, the inventors performed numerical simulations. The results are shown below. In the simulations, an erbium-doped optical fiber was used as the optical amplification medium 21, an optical fiber coupler was used as the splitter 23, a carbon nanotube was used as the saturable absorber 24, and a single-mode optical fiber was used as the first optical path 201, the second optical path 202, and the third optical path 203.

First, the inventors performed a simulation for verifying multi-pulse oscillation in a mode-locked fiber laser. A graph GA shown in FIG. 21 is a graph showing examples of an initial value set at the 0th circulation after the start of excitation in this simulation. In the graph GA, the vertical axis indicates wavelength (unit: nm), the horizontal axis indicates time (unit: ps), and the shade of color indicates light intensity (any unit). A graph GB drawn along the vertical axis shows a relationship between the wavelength and the light intensity, and a graph GC drawn along the horizontal axis shows a relationship between the time and the light intensity. As shown in FIG. 21, it can be seen that random noise occupies most of the light components in the initial values immediately after the start of excitation. This simulation was performed by setting initial values as shown in FIG. 21 and overlapping the number of circulations.
(a) in FIG. 22 is a graph showing changes in the peak power of the optical pulse for each circulation in this simulation. In (a) in FIG. 22, the vertical axis indicates peak power (unit: W), and the horizontal axis indicates the number of circulations. Referring to (a) in FIG. 22, it can be seen that the laser oscillation state was reached in about 800 circulations in this simulation. In addition, (b) in FIG. 22 is a graph showing a relationship between the saturation energy of an optical amplification medium and the peak power of the optical pulse in this simulation. In (b) in FIG. 22, the vertical axis indicates peak power (unit: W), and the horizontal axis indicates the saturation energy Esat (unit: pJ) of the optical amplification medium. Referring to (b) in FIG. 22, in this simulation, the peak power gradually increases as the saturation energy Esat increases in a range in which the saturation energy Esat does not exceed 400 pJ. However, when the saturation energy Esat exceeds 400 pJ, the relationship between the saturation energy Esat and the peak power begins to be disturbed, and in a range in which the saturation energy Esat exceeds 500 pJ, the peak power drops to about half of the value immediately before that. This means that double pulse oscillation occurs when the excitation light intensity increases, and suggests that the number of pulses increases as the excitation light intensity increases.

FIGS. 23 to 26 are graphs showing time waveforms of optical pulses generated when the saturation energy Esat is fixed at 600 pJ and different random noises are set as initial values in the simulation described above. In FIGS. 23 to 26, (a) shows the time waveform of random noise that is an initial value, and (b) shows the time waveform of an optical pulse generated corresponding to (a). In (a) and (b), the vertical axis indicates light intensity (any unit), and the horizontal axis indicates time (unit: ps). The pulse interval in (b) in FIG. 23 is 4 ps, the pulse interval in (b) in FIG. 24 is 31 ps, the pulse interval in (b) in FIG. 25 is 26 ps, and the pulse interval in (b) in FIG. 26 is 14 ps. From this result, it can be seen that the pulse interval is indefinite when double pulse oscillation is performed by simply increasing the excitation light intensity.

Subsequently, a simulation was performed by using the configuration of the embodiment described above. FIGS. 27 to 30 are graphs showing simulation results. In FIGS. 27 to 30, (a) shows a time waveform at the 1000th circulation, (b) shows a time waveform at the 2000th circulation, and (c) shows a time waveform at the 5000th circulation. In (a) to (c), the vertical axis indicates light intensity (any unit), and the horizontal axis indicates time (unit: ps). In this simulation, first, laser oscillation was performed with a single pulse, and the single pulse was converted into the optical pulse train Pe by the waveform controller 30 at the 2000th circulation. At this time, the time interval between the optical pulses included in the optical pulse train Pe was set to 100 ps (FIGS. 27 and 28) or 300 ps (FIGS. 29 and 30). The saturation energy Esat was fixed at 300 pJ up to the 2000th circulation, and fixed at 600 pJ from the 2001st circulation. The initial values of the time waveforms at the 0th circulation in FIGS. 27 to 30 are the same as in (a) in FIGS. 23, 24, 25, and 26, respectively.

Referring to FIGS. 27 to 30 (especially (b) and (c) in each diagram), in the configuration of the embodiment described above, it can be seen that laser oscillation occurs while maintaining the number of pulses (two pulses) and the time interval (100 ps or 300 ps) of the optical pulse train Pe applied by the waveform controller 30. Thus, according to the optical pulse generation device 1A and the optical pulse generation method of the embodiment described above, it is possible to stably output the laser light, which is an optical pulse train including two or more temporally close ultrashort optical pulses, with a predetermined number of pulses and a predetermined time interval with good reproducibility.

FIG. 31 is a graph showing the verification result of the controllability of the time interval between optical pulses in the embodiment described above. (a) to (d) in FIG. 31 show cases where the time interval between two optical pulses forming the optical pulse train Pe is set to 20 ps, 50 ps, 100 ps, and 150 ps. The saturation energy Esat and the waveform control timing are the same as in FIGS. 27 to 30. As a result of the simulation, the time interval between optical pulses after laser oscillation was 21.3 ps, 50.2 ps, 100 ps, and 150 ps. Thus, according to the embodiment described above, the simulation showed that a desired pulse interval could be realized even though a slight error was included.

FIG. 32 is a graph showing the verification result of the controllability of the number of optical pulses in the embodiment described above. (a) to (d) in FIG. 32 show cases where the number of optical pulses forming the optical pulse train Pe is set to 1, 2, 3, and 4. For each number of pulses in (a) to (d) in FIG. 32, the saturation energy Esat was set to 300 pJ, 600 pJ, 900 pJ, and 1200 pJ. All the time intervals between the optical pulses were set to 50 ps. The waveform control timing is the same as in FIGS. 27 to 30. As a result of the simulation, the number of optical pulses after laser oscillation is 1, 2, 3, and 4. Therefore, according to the embodiment described above, the result of the simulation showed that the number of pulses of the optical pulse train Pe is maintained even after laser oscillation.

Next, a simulation will be described in which the number of optical pulses forming the optical pulse train Pe is changed multiple times. FIG. 33 is a graph showing how the number of optical pulses changes in this simulation. In FIG. 33, the vertical axis indicates the number of circulations, the horizontal axis indicates time (unit: ps), and the shade of color indicates light intensity (any unit). The lighter the color, the larger the light intensity. FIGS. 34 to 36 are graphs showing time waveforms of an optical pulse train laser-oscillating at each stage of change in the number of optical pulses. In FIGS. 34 to 36, the vertical axis indicates light intensity (any unit), and the horizontal axis indicates time (unit: ps). (a) in FIG. 37 is a graph showing changes in the saturation energy Esat according to the number of circulations. In (a) in FIG. 37, the vertical axis indicates the saturation energy Esat (unit: pJ), and the horizontal axis indicates the number of circulations. (b) in FIG. 37 is a graph showing changes in the peak power of the optical pulse according to the number of circulations. In (b) in FIG. 37, the vertical axis indicates peak power (unit: W), and the horizontal axis indicates the number of circulations.

In this simulation, at the 0th to 1999th circulations, the saturation energy Esat was set to a magnitude (approximately 20 pJ) corresponding to a single pulse. At this time, as shown in (b) in FIG. 37, laser oscillation occurred at about 1500 circulations, generating single-pulse ultrashort pulsed laser light ((a) in FIG. 34). Then, at the 2000th circulation, the single-pulse ultrashort pulsed laser light was converted into an optical pulse train including two optical pulses (time interval of 100 ps), and the saturation energy Esat was changed to a magnitude (approximately 40 pJ) corresponding to the two optical pulses. Then, at the 2000th to 2999th circulations, the optical pulse train was laser-amplified ((b) in FIG. 34). Subsequently, at the 3000th to 3999th circulations, the saturation energy Esat was reduced to a magnitude (approximately 20 pJ) corresponding to the single pulse. Then, as shown in (b) in FIG. 37, the peak power of the two optical pulses was once greatly reduced, but as shown in FIG. 33, one of the two optical pulses disappeared at about 3400 circulations and the remaining one optical pulse was laser-amplified to return to the single-pulse ultrashort pulsed laser light ((c) in FIG. 34).

Subsequently, at the 4000th circulation, the single-pulse ultrashort pulsed laser light was converted into an optical pulse train including three optical pulses (time interval of 100 ps), and the saturation energy Esat was changed to a magnitude (approximately 60 pJ) corresponding to the three optical pulses. Then, at the 4000th to 4999th circulations, the optical pulse train was laser-amplified ((a) in FIG. 35). Subsequently, at the 5000th to 5999th circulations, the saturation energy Esat was reduced again to a magnitude (approximately 20 pJ) corresponding to the single pulse. As a result, as shown in (b) in FIG. 37, the peak power of the three optical pulses was once greatly reduced and then, as shown in FIG. 33, one of the three optical pulses disappeared at about 5300 circulations and another one disappeared at about 5500 circulations and only one optical pulse was left to return to the single-pulse ultrashort pulsed laser light ((b) in FIG. 35).

Subsequently, at the 6000th circulation, the single-pulse ultrashort pulsed laser light was converted into an optical pulse train including four optical pulses (time interval of 100 ps), and the saturation energy Esat was changed to a magnitude (approximately 80 pJ) corresponding to the four optical pulses. Then, at the 6000th to 6999th circulations, the optical pulse train was laser-amplified ((c) in FIG. 35). Subsequently, at the 7000th to 7999th circulations, the saturation energy Esat was reduced again to a magnitude (approximately 20 pJ) corresponding to the single pulse. As a result, as shown in (b) in FIG. 37, the peak power of the four optical pulses was once greatly reduced and then, as shown in FIG. 33, two of the four optical pulses disappeared up to 7500 circulations and another one disappeared up to 7700 circulations and only one optical pulse was left to return to the single-pulse ultrashort pulsed laser light ((a) in FIG. 36).

Subsequently, at the 8000th circulation, the single-pulse ultrashort pulsed laser light was converted into an optical pulse train including three optical pulses with unequal time intervals (time intervals of 100 ps and 200 ps) and the saturation energy Esat was changed to a magnitude (approximately 60 pJ) corresponding to the three optical pulses. Then, at the 8000th to 8999th circulations, the optical pulse train was laser-amplified ((b) in FIG. 36). Subsequently, at the 9000th to 10000th circulations, the saturation energy Esat was reduced again to a magnitude (approximately 20 pJ) corresponding to the single pulse. As a result, as shown in (b) in FIG. 37, the peak power of the three optical pulses was once greatly reduced and then, as shown in FIG. 33, two of the three optical pulses disappeared up to 9300 circulations and only one optical pulse was left to return to the single-pulse ultrashort pulsed laser light ((c) in FIG. 36).

From this simulation result, it can be seen that according to the embodiment described above, the laser light, which is an optical pulse train including two or more ultrashort optical pulses, can be stably output with good reproducibility while changing the number of pulses and the time interval. As in this simulation, before changing at least one of the number of optical pulses and the time interval after outputting the laser light including two or more optical pulses, the number of optical pulses may be reduced to one by changing the light intensity of the excitation light to a magnitude corresponding to a single optical pulse, and the one optical pulse may be amplified as laser light in the optical resonator. In this manner, by reducing the number of optical pulses to one before generating two or more optical pulses by waveform control, any number of optical pulses can be stably generated.

Here, advantages of making the center wavelengths of two or more optical pulses forming an optical pulse train different from each other will be described in detail. FIG. 38 is a graph showing a time waveform of an optical pulse train including 19 optical pulses generated by a spectral domain modulation type waveform controller. In FIG. 38, the vertical axis indicates light intensity (any unit), and the horizontal axis indicates time (unit: ps). As shown in this graph, when an optical pulse train is generated by the spectral domain modulation type waveform controller (for example, the pulse shaper 32A in FIG. 3), the peak power of the optical pulse tends to decrease with a distance from the time center of the optical pulse train. Therefore, since the loss increases as the time interval between optical pulses increases, the time interval between optical pulses that can be realized is substantially limited. Therefore, a method of increasing the time interval between optical pulses by making the center wavelengths of two or more optical pulses forming the optical pulse train different from each other, which will be described below, is effective.

FIG. 39 is a graph showing changes in a time waveform when the time waveform is controlled multiple times by the pulse shaper 32A in a case where the center wavelengths of two or more optical pulses forming an optical pulse train are the same with each other. FIG. 40 is a graph showing changes in a time waveform when the time waveform is controlled multiple times by the pulse shaper 32A in a case where the center wavelengths of two or more optical pulses forming an optical pulse train are different from each other. In FIGS. 39 and 40, (a) shows after the first waveform control, (b) shows after the second waveform control, (c) shows after the third waveform control, and (d) shows after the fourth waveform control. As shown in (a) to (d) in FIG. 39, when the center wavelengths are the same, if the waveform is controlled multiple times, the number of optical pulses and the time interval become unstable. On the other hand, as shown in (a) to (d) in FIG. 40, when the center wavelengths are different, if the waveform is controlled multiple times, the time interval gradually increases (or decreases) while maintaining the number of optical pulses. In addition, since the center wavelengths of the respective pulses are different, the traveling speed of each optical pulse differs due to the chromatic dispersion in the optical resonator. Therefore, the pulse interval increases or decreases in addition to the waveform controlled amount.

However, the increase or decrease in time interval caused by such chromatic dispersion does not last forever. (a) to (c) in FIG. 41 are graphs showing three optical pulses having different center wavelengths each other. In (a) to (c) in FIG. 41, the vertical axis indicates light intensity (any unit), and the horizontal axis indicates wavelength (unit: nm). The center wavelength of the optical pulse in (a) in FIG. 41 is 1553 nm, the center wavelength of the optical pulse in (b) in FIG. 41 is 1550 nm, and the center wavelength of the optical pulse in (c) in FIG. 41 is 1547 nm. In the simulation, the three optical pulses circulated simultaneously in the optical resonator, and as a result, the time waveforms of the respective optical pulses converged to time waveforms shown in (a) to (c) in FIG. 42. (a) to (c) in FIG. 42 correspond to (a) to (c) in FIG. 41, respectively. The center wavelengths of the respective optical pulses shown in (a) to (c) in FIG. 42 were all 1550 nm.

FIG. 43 is a graph showing how the center wavelength of each optical pulse converges. In FIG. 43, a graph G31 shows changes in the center wavelength of an optical pulse whose initial center wavelength is 1553 nm. A graph G32 shows changes in the center wavelength of an optical pulse whose initial center wavelength is 1550 nm. A graph G33 shows changes in the center wavelength of an optical pulse whose initial center wavelength is 1547 nm. As shown in FIG. 43, the center wavelength of each optical pulse converged to 1550 nm up to about 150 circulations.

Thus, even if the center wavelengths of two or more optical pulses forming an optical pulse train are initially different, the center wavelengths of the respective optical pulses gradually converge to one wavelength by performing waveform control multiple times. In addition, after the center wavelength converges, the time interval between the optical pulses does not increase or decrease any further. In addition, the magnitude of the increased time interval can be theoretically calculated from the magnitude of the difference between the center wavelengths, the chromatic dispersion in the optical resonator, and the like.

FIGS. 44 to 46 are graphs showing results obtained by performing waveform control for conversion into three optical pulses having different center wavelengths each other over ten circulations in a simulation. Each of FIGS. 44 to 46 shows the time waveform of the optical pulse, and the vertical axis indicates light intensity (any unit) and the horizontal axis indicates time (unit: ps). (a) in FIG. 44 shows a single pulse (ultrashort pulsed laser light Pb) at the 499th circulation (before waveform conversion). (b) and (c) in FIG. 44, (a) to (c) in FIG. 45, and (a) to (c) in FIG. 46 show optical pulse trains at 500th, 501st, 502nd, 503rd, 504th, 508th, 509th, and 1000th circulations, respectively. In this simulation, waveform control was continuously performed over a total of 10 circulations from the 500th circulation to the 509th circulation. An increment of the time interval between optical pulses given by one control was set to 10 ps. The intensity of each pulse was adjusted to correct the intensity variation of the pulse train due to the wavelength dependence of the gain in the amplifying fiber.
(a) in FIG. 47 is a graph showing changes in the peak position of each optical pulse, and (b) in FIG. 47 is a graph showing a portion of the 500th to 510th circulations in (a) in FIG. 47 in an enlarged manner. In FIG. 47, the vertical axis indicates peak position (unit: ps, the peak position of the central optical pulse is set to 0), and the horizontal axis indicates the number of circulations.

As shown in FIGS. 44 to 47, the time interval between the three optical pulses having different center wavelengths each other increased each time the waveform control was repeated, reaching 100 ps as designed at the 509th circulation. Thereafter, the time waveform gradually expanded for a while after the end of the waveform control, and the time interval between the optical pulses stopped increasing further at about 600 circulations and the peak position of each optical pulse stabilized. The time interval after stabilization was 121 ps in this simulation. The expansion of the time waveform even after the end of the waveform control is due to the influence of chromatic dispersion (group velocity dispersion) of the optical fiber in the optical resonator 20. Therefore, in order to accurately control the time interval between optical pulses, it is necessary to take the chromatic dispersion (group velocity dispersion) into consideration. In this simulation, time waveform control was performed over multiple circulations. However, even if the time waveform control is performed only for a single circulation, it is possible to increase the time interval between the optical pulses due to chromatic dispersion (group velocity dispersion).

The optical pulse generation device and the optical pulse generation method of the present disclosure are not limited to the above-described embodiments and modification examples, and various modifications are possible. For example, in the embodiments described above, the number of two or more optical pulses forming the optical pulse train Pe and the time interval therebetween are variable. However, only one of the number of optical pulses and the time interval may be variable, or both the number of optical pulses and the time interval may be fixed.

In addition, although the pulse shaper 32A is exemplified as the waveform control device 32 in the embodiment described above, the waveform control device 32 may be configured by an AOPDF (Acousto-optic programmable dispersive filter), a combination of a splitter and a delayer, an integrated control chip, or the like.

The AOPDF is a device configured to include an acousto-optic element. By appropriately applying sound waves to the acousto-optic element, the intensity spectrum and the phase spectrum of the light passing through the acousto-optic element can be controlled. As a result, the incident ultrashort optical pulse can be controlled in the frequency domain, so that the incident ultrashort optical pulse can be converted into an optical pulse train.

FIG. 48 is a schematic diagram showing a pulse splitter 32B, which is a combination of splitters and delayers, as an example of the waveform control device 32. The pulse splitter 32B is mainly configured to include splitters 371 and 372, couplers 373 and 374, delay lines 381 and 382, attenuators (strength attenuators) 391 to 394, and mirrors 401 to 404. When a single optical pulse P1 (corresponding to the ultrashort pulsed laser light Pb in FIG. 1) is input to the pulse splitter 32B, the single optical pulse P1 is split into two by the splitter 371. One split single optical pulse P11 passes through the attenuator 391 and reaches the coupler 373. The other split single optical pulse P12 passes through the delay line 381 and the attenuator 392 and reaches the coupler 373. These single optical pulses P11 and P12 are combined by the coupler 373 with a time difference by the delay line 381 to form an optical pulse train P2 including two optical pulses.

The optical pulse train P2 is split into two by the splitter 372. One split optical pulse train P21 passes through the delay line 382 and the attenuator 393 and reaches the coupler 374. The other split optical pulse train P22 passes through the attenuator 394 and reaches the coupler 374. These optical pulse trains P21 and P22 are combined by the coupler 374 with a time difference by the delay line 382 to form an optical pulse train P3 including four optical pulses. The optical pulse train P3 is output as the optical pulse train Pe shown in FIG. 1.

In the pulse splitter 32B, it is possible to change the number of optical pulses forming the optical pulse train by changing the number of splitters. By changing the amount of delay in the delay line, it is possible to change the time interval between the optical pulses forming the optical pulse train.

The integrated control chip is a miniaturized one obtained by integrating, for example, the pulse splitter 32B shown in FIG. 48, an optical modulator, and a CMOS circuit on a single substrate.

### INDUSTRIAL APPLICABILITY

The embodiments can be used as an optical pulse generation device and an optical pulse generation method capable of stably outputting laser light, which is an optical pulse train including two or more temporally close ultrashort optical pulses, with a predetermined number of pulses and a predetermined time interval with good reproducibility.

### REFERENCE SIGNS LIST

1A, 1B: optical pulse generation device, 20: optical resonator, 21: optical amplification medium, 22: isolator, 23: splitter, 24: saturable absorber, 25: coupler, 30: waveform controller, 31: optical path switch, 32: waveform control device, 32A: pulse shaper, 33: coupler, 34: waveform controller, 35: polarization switch, 36: waveform control device, 41: controller for waveform control, 42: pump laser, 43: current controller, 44: function generator, 45: splitter, 46: photodetector, 47: pulse generator, 201: first optical path, 202: second optical path, 203: third optical path, 321: diffraction grating, 322: lens, 323: spatial light modulator (SLM), 324: lens, 325: diffraction grating, 326: modulation surface, 327: modulation region, AA, AB: direction, Jd: drive current, Lout: laser light, Pa: excitation light, Pb: ultrashort pulsed laser light, Pc: light, Pd: modulated light, Pe: optical pulse train, Pn: light, Pout, Pout1, Pout2: laser light, Sc1, Sc2: control signal, Sd: detection signal, ST14, ST24, ST34: waveform control step, ST17, ST27, ST37: output step, Sy: synchronization signal.

1: An optical pulse generation device, comprising:
an optical resonator of mode-locked type, the optical resonator including an optical amplification medium and being configured to generate, amplify, and output laser light;
a light source optically coupled to the optical resonator and configured to supply excitation light to the optical amplification medium; and
a waveform controller arranged in the optical resonator and configured to control a time waveform of the laser light within a predetermined period to convert the laser light into an optical pulse train including two or more optical pulses within a period of the optical resonator,
wherein the optical resonator amplifies the optical pulse train after the predetermined period and outputs the optical pulse train having amplified as the laser light.

2: The optical pulse generation device according to claim 1,
wherein a number of the two or more optical pulses and a time interval between the two or more optical pulses are variable.

3: The optical pulse generation device according to claim 1,
wherein a number of the two or more optical pulses is variable, a light intensity of the excitation light is variable, and the light intensity of the excitation light increases as the number of the two or more optical pulses forming the optical pulse train increases.

4: The optical pulse generation device according to claim 1,
wherein the waveform controller includes:
an optical path switch having at least one input port and at least two output ports; and
a waveform control device configured to control the time waveform of the laser light to convert the laser light into the optical pulse train,
the optical resonator includes:
a first optical path having one end optically coupled to the one input port of the optical path switch;
a second optical path having one end optically coupled to one of the output ports of the optical path switch and another end optically coupled to another end of the first optical path; and
a third optical path having one end optically coupled to another one of the output ports of the optical path switch and another end optically coupled to another end of the first optical path,
the optical amplification medium is arranged on the first optical path,
the waveform control device is arranged on the third optical path, and
the optical path switch selects the third optical path in the predetermined period and selects the second optical path in another period.

5: The optical pulse generation device according to claim 4, further comprising:
a photodetector optically coupled to the optical resonator and configured to detect light output from the optical resonator to generate an electrical detection signal; and
a switch controller configured to control the optical path switch,
wherein the switch controller determines a timing for selecting the third optical path based on the detection signal from the photodetector.

6: The optical pulse generation device according to claim 1,
wherein the waveform controller includes:
a polarization switch arranged in the optical resonator and configured to control a polarization plane of the laser light; and
a waveform control device configured to control the time waveform of the laser light to convert the laser light into the optical pulse train when the laser light has a first polarization plane, the waveform control device being configured not to control the time waveform of the laser light when the laser light has a second polarization plane different from the first polarization plane, and
the polarization switch sets the polarization plane of the laser light to the first polarization plane in the predetermined period and sets the polarization plane of the laser light to the second polarization plane in another period.

7: The optical pulse generation device according to claim 6, further comprising:
a photodetector optically coupled to the optical resonator and configured to detect light output from the optical resonator to generate an electrical detection signal; and
a switch controller configured to control the polarization switch,
wherein the switch controller determines a timing for setting the polarization plane of the laser light to the first polarization plane based on the detection signal from the photodetector.

8: The optical pulse generation device according to claim 1,
wherein the optical resonator generates the laser light as a single pulse before the predetermined period, and
the waveform controller includes:
a spectral element for spectral diffraction of the laser light;
a spatial light modulator configured to modulate at least one of an intensity spectrum and a phase spectrum of the laser light after spectral diffraction in order to convert the laser light into the optical pulse train, the spatial light modulator outputting modulated light; and
an optical system configured to condense the modulated light and output the optical pulse train.

9: The optical pulse generation device according to claim 1,
wherein the optical resonator generates a continuous wave as the laser light before the predetermined period, and
the waveform controller converts the laser light into the optical pulse train by modulating an intensity of the laser light.

10: The optical pulse generation device according to claim 1,
wherein center wavelengths of the two or more optical pulses immediately after being converted by the waveform controller are the same with each other.

11: The optical pulse generation device according to claim 1,
wherein center wavelengths of the two or more optical pulses immediately after being converted by the waveform controller are different from each other.

12: The optical pulse generation device according to claim 10,
wherein the time waveform of the laser light is controlled only once in the predetermined period.

13: The optical pulse generation device according to claim 11,
wherein the time waveform of the laser light is controlled multiple times in the predetermined period.

14: The optical pulse generation device according to claim 1,
wherein a time interval between the two or more optical pulses is 10 femtoseconds or more and 10 nanoseconds or less.

15: An optical pulse generation method, comprising:
performing a laser light generation of generating and amplifying laser light in an optical resonator of mode-locked type by applying excitation light to an optical amplification medium in the optical resonator;
performing a waveform control of controlling a time waveform of the laser light in the optical resonator within a predetermined period to convert the laser light into an optical pulse train including two or more optical pulses within a period of the optical resonator; and
performing an output of amplifying the optical pulse train in the optical resonator after the predetermined period and outputting the optical pulse train having amplified to an outside of the optical resonator as the laser light.

16: The optical pulse generation method according to claim 15,
wherein, after the output, at least one of a number of the two or more optical pulses and a time interval between the two or more optical pulses is changed to repeat the waveform control and the output.

17: The optical pulse generation method according to claim 16,
wherein, in the output, a light intensity of excitation light applied to the optical amplification medium increases as the number of the two or more optical pulses forming the optical pulse train increases.

18: The optical pulse generation method according to claim 17,
wherein, before repeating the waveform control after the output, the number of the two or more optical pulses is reduced to one by changing the light intensity of the excitation light applied to the optical amplification medium from a magnitude corresponding to the number of the two or more optical pulses forming the optical pulse train to a magnitude corresponding to one optical pulse, and one optical pulse is amplified as the laser light in the optical resonator.

19: The optical pulse generation method according to claim 15,
wherein center wavelengths of the two or more optical pulses immediately after being converted by the waveform control are the same with each other.

20: The optical pulse generation method according to claim 15,
wherein center wavelengths of the two or more optical pulses immediately after being converted by the waveform control are different from each other.

21: The optical pulse generation method according to claim 19,
wherein the time waveform of the laser light is controlled only once in the predetermined period.

22: The optical pulse generation method according to claim 20,
wherein the time waveform of the laser light is controlled multiple times in the predetermined period.

23: The optical pulse generation method according to claim 15,
wherein a time interval between the two or more optical pulses is 10 femtoseconds or more and 10 nanoseconds or less.
